(19) United States
(12) Patent Application Publication
(10) Pub. No.: US 2007/0136095 A1
(43) Pub. Date: Jun. 14, 2007

(54) Icon Queues for Workflow Management

(75) Inventor: Ronald S. Weinstein, Tucson, AZ (US)

Correspondence Address: QUARLES & BRADY LLP, ONE SOUTH CHURCH AVENUE, SUITE 1700, TUCSON, AZ, 85701-1621, US

(73) Assignee: Arizona Board of Regents on Behalf of The University of Arizona, Tucson, AZ (US)

(21) Appl. No.: 11/608,146

(22) Filed: Dec. 7, 2006

Related U.S. Application Data
(60) Provisional application No. 60/748,966, filed on Dec. 9, 2005.

(51) Int. Cl. G06Q 10/00; G06F 19/00

(52) U.S. Cl. 705/2; 705/3

(57) ABSTRACT

Telemedicine is the practice of medicine at a distance by physicians dispersed over small to large geographic locations. The scheduling and tracking the activities of a plurality of physicians who deliver professional services by telemedicine, namely telephysicians, at discontinuous geographic locations is cumbersome and inefficient. This invention describes a command and control system for managing the schedules of decentralized physicians, tracking their activities, and managing other human resources in a decentralized healthcare system. The command and control system uses computer graphic elements (e.g. icons) as telephysician identifiers. Each icon is unique in appearance and represents an individual service provider. Icons can be electronically inserted into queue diagrams represented at the presentation layer of the command and control system. Icons are archived in an icon library and linked to physician personnel records. These icons are used for many tasks including adding healthcare service providers to case work lists and sorting healthcare providers according to qualifications such as expertise.

### CROSS REFERENCE TO RELATED APPLICATIONS

This application claims the benefit of priority to U.S. Provisional Application No. 60/748,966 entitled “Icon Queues for Workflow Management” filed on Dec. 9, 2005, the entire contents of which are incorporated by reference.

### BACKGROUND OF THE INVENTION

1. Field of the Invention

The present invention pertains generally to medical services and, more particularly, to a command and control system for multi-specialty telemedicine practices.

2. Description of the Prior Art

Prior Art Group 1: The prior art concerning clinical pathways is explained first. A clinical pathway refers to a standard or optimum care process. It is also sometimes called a “critical pathway.” “Clinical guidelines” describe optimal clinical service. This specification assumes that clinical pathways include clinical guidelines. Here, a “care process” represents a series of clinical services.

The management of patients with many diseases according to clinical pathways involves the participation of a number of different types of medical specialists. For example, the care of a breast cancer patient may require the services of a primary care physician, a radiologist, a pathologist, a surgeon, an oncologist, a therapeutic radiologist, and possibly others, depending on the patient's diagnosis. These services are provided one after another, and often spread out over many weeks or months. This is inconvenient for the patient, is costly, and results in anxiety and frustration for many patients.

Prior Art Group 2: This group concerns the practice of telemedicine. Telemedicine is the practice of medicine at a distance using audio, video, and telecommunications technologies. Typically, telemedicine consultations involve single specialty services or consultations, such as teleradiology, teledermatology, or telepsychiatry. The major benefit of telemedicine has been to bring specialty medical services to geographically underserved populations, such as rural communities or prison populations. In addition to providing increased access to healthcare services, telemedicine reduces the need for patients to travel to obtain services. Telemedicine has not been used to any major extent to increase the efficiency of on-site multi-specialty clinical practices. In fact, telemedicine as currently utilized by clinics often decreases efficiency by increasing paper work and increasing the number of appointments necessary for the patient to be seen by an on-site physician and then rescheduled with an off-site teleconsultant. Most telemedicine services are provided in an uncoordinated way by individual clinical services, such as psychiatry, dermatology, radiology, or pathology.

Prior Art Group 3: Attempts to automate or streamline various aspects of patient care have been the subject of numerous inventions. U.S. Pat. No. 6,804,656 to Rosenfield et al. was issued for “System and Method for Providing Continuous, Expert Network Critical Care Services from Remote Locations.” The disclosed invention is for providing critical care services by telemedicine from a remote location.

U.S. Pat. No. 6,786,406 to Maningas was issued for “Medical Pathways Rapid Triage System.” The disclosed computer based system provides for the rapid triage of multiple patients in hospital emergency department settings that allows flexibility in the order of the entry of data.

U.S. Pat. No. 5,868,669 to Iliff was issued for “Computerized Medical Diagnostic and Treatment Advice System.” The disclosed invention is for a system and method for providing computerized knowledge based medical diagnostic and treatment advice to the general public over a telephone network.

U.S. Pat. No. 5,823,948 to Ross, Jr. et al was issued for “Medical Records Documentation, Tracking and Order Entry System.” The disclosed invention is for a system and method that computerizes medical records, documentation, tracking and order entries. A video system can be employed to videotape a patient's consent.

U.S. Pat. No. 5,544,649 to David et al. was issued for “Ambulatory Patient Health Monitoring Techniques Utilizing Interactive Visual Communications.” The disclosed invention is for an interactive visual system, which allows monitoring of patients at remote sites. Electronic equipment and sensors are used at the remote site to obtain data from the patient, which is sent to the monitoring site.

U.S. Pat. No. 5,812,983 to Kumagai was issued for “Computer Medical File and Chart System.” The disclosed invention is for a system and method which integrates and displays medical data in which a computer program links a flow sheet of a medical record to medical charts.

U.S. Pat. No. 5,216,596 to Weinstein was issued for “Telepathology Diagnostic Network.” The disclosed invention is for a method and apparatus for providing pathology diagnostic services over a telecommunication network and providing access to pathology experts.

U.S. Pat. No. 4,489,387 to Lamb et al. was issued for “Method and Apparatus for Coordinating Medical Procedures.” The disclosed invention is for a method and apparatus that coordinates two or more medical teams to evaluate and treat a patient at the same time without repeating the same steps.

U.S. Pat. No. 4,731,725 to Suto et al. issued for “Data Processing System which Suggests a Pattern of Medical Tests to Reduce the Number of Tests Necessary to Confirm or Deny a Diagnosis.” The disclosed invention is for a data processing system that uses decision trees for diagnosing a patient's systems to confirm or deny a patient's ailment.

While these inventions provide useful records management and patient tools, none of them provides a multi-specialty process for increasing clinic patient throughput by providing just-on-time diagnostic and/or consultative services from off-site service providers using telemedicine techniques.

Prior Art Group 4: This group concerns computer networking. Grid computing is a form of computer networking. Grid computing networks are unlike conventional networks in that the focus is on connecting computing devices in order to share unused processing cycles. Grid computing networks are generally utilized for solving problems too intensive for any stand-alone machine. Grid computing will have a role as computer aided diagnostic applications are developed and images evolve from 2-D to 3-D.

Parallel computing is a type of computing in which a task is broken down into multiple processes which are distributed over multiple independent processors. By linking the processors, execution time for difficult tasks can be greatly reduced. Parallel computing is highly dependent on software programs to efficiently distribute tasks among the various processors. While grid computing is generally sharing the computing resources over the wide area network, parallel computing is sharing resources within the same local area.

Distributed computing is a type of computing in which different components and objects comprising an application can be located on different computers connected to a network. Distributed computing allows for scheduling functions to be processed by one computer while request queuing is being processed by another computer elsewhere in the network.

Distributed computing will have the most immediate impact on resolving the data access and storage issues associated with digitized medical images. For example, applying this concept to pathology, data storage can be distributed across the system over the local area network as well as the wide area network.

Distributed computing solutions are available through most major information technology vendors. As an example, IBM provides a number of “turn-key” implementations of multi-tiered data storage infrastructures.

Prior Art Group 5: This group concerns the use of computer graphic elements (e.g., icons) to represent various entities such as jobs, objects, ideas, and others. Generally, icons are a graphic representation and may be predefined by a computer program or an image file. Icons are subject of numerous inventions. Of particular relevance are the following:

U.S. Pat. No. 6,278,455 to Barker was issued for “Pictorial interface for accessing information in an electronic file system.” The disclosed invention uses pictorial objects as icons which can be animated and are linked to files that are retrieved with pictorial object commands. The icons identify files containing pictorial elements, not individuals.

U.S. Pat. No. 6,810,149 to Squilla et al was issued for “Method and system for cataloging image.” The disclosed invention uses photographs or text as personalized image icons. Unlike the present invention, it does not provide a method for assembling representational icons that fuse multiple graphically coded identifier features or hide the actual personal identity of the individual being representing.

### SUMMARY OF THE INVENTION

The present invention relates to information systems for medical practices. In particular, the present invention concerns providing a method and system for providing a patient at a single physical location with the plurality of telemedicine services originating from one or a plurality of other locations. Since many current sites of healthcare delivery are relatively limited with respect to their scope of services on-site, a combination of on-site and off-site services, some of which are delivered by telemedicine, are used to enable a patient to complete a clinical pathway in a single day. This invention describes a system and method for enrolling physicians at computer workstations to provide professional services and then tracking, in real time, their patient care activities. A novel personal identification system based on unique personal identifiers or icons (UPIs) is described. The use of UPIs to represent individual physician participation in the workflow of clinics with decentralized staffs simplifies scheduling and increases the efficiency of the physician workforce.

Further, the present invention provides a medical service provider interface for a command and control system that is used to manage a core business of super-rapid throughput clinical pathway clinics. This e-solution uses a network, database, rapid throughput laboratories, and a command and control system to expedite physician enrollment for active cases, increase patient throughput in clinics and consolidate many complex patient workups into a single day. Again, the use of UPIs according to the present invention facilitates the self-assignment of service providers to work lists and the timely tracking of work flow through a clinic. Tracking information is also used by system managers and patients to follow the progress of individual patients through clinical pathways. Using a telemedicine service model, combining on-site face-to-face encounters and off-site telemedicine encounters or telediagnostic services, there is improved patient access to healthcare services, increased patient compliance, and reduced overall cost per case.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a queue diagram of a clinical pathway for the diagnosis and treatment planning of breast disease patients;

FIG. 2 illustrates the interrelation between a clinic, either within a hospital or free-standing, and a telemedicine service provider;

FIG. 3 illustrates a queue diagram of a clinical pathway for breast disease incorporating teleradiology and telepathology;

FIG. 4A illustrates an operational overview of a medical service command and control system;

FIG. 4B illustrates an example embodiment of a plurality of computer systems which can be incorporated into an overall command and control system according to the present invention in block diagram format;

FIG. 4C illustrates a block diagram of an example configuration of a series of modules which can implement various aspects of the present invention;

FIG. 5 illustrates a command and control system for teleradiology services;

FIG. 6 illustrates a command and control system for telehealth and telemedicine services;

FIG. 7 illustrates the components of an example of the use of computer graphic elements (e.g. icons) to generate a unique personal icon (UPI), representing an individual healthcare service provider;

FIG. 8 illustrates the customization and assembly of a UPI;

FIG. 9 illustrates a queue diagram of a laboratory workup segment of a clinical pathway for breast care for a single patient as displayed on a video monitor;

FIG. 10 illustrates a queue diagram of a laboratory workup segment of a clinical pathway for breast care of a single patient as viewed on a video monitor, where an “on-call window” in which UPIs representing individual service providers are displayed;

FIG. 11 illustrates a queue diagram a laboratory workup segment of a clinical pathway for breast care showing the on-call window in which a unique personal icon representing an individual service provider is displayed on a video monitor;

FIG. 12 illustrates a queue diagram of laboratory workup segment of a clinical pathway for breast care showing an on-call window in which the UPI representing an individual service provider has been clicked-and-dragged into the queue for diagnosing hematoxylin and eosin (H & E) stained histopathology slides by telepathology;

FIG. 13 illustrates a queue diagram of laboratory workup segment of a clinical pathway for breast care showing an on-call window in which the UPI representing an individual service provider has been electronically duplicated by copy and paste instructions and displayed as a second icon in the on call window on the video monitor;

FIG. 14 illustrates a queue diagram laboratory workup segment of a clinical pathway for breast care representing data from a single patient showing an on-call window in which the UPI representing an individual service provider has been duplicated (“electrically cloned”) in the on-call window and then clicked-and-dragged to the specimen workflow processing line;

FIG. 15 illustrates a queue diagram of a laboratory workup segment of a clinical pathway for a breast care patients showing an on-call window in which the UPI representing an individual service provider has been “electrically cloned” a second time in the on-call window;

FIG. 16 illustrates a queue diagram of a laboratory workup segment of a clinical pathway for breast care showing an on-call window in which a UPI representing an individual service provider has been electronically duplicated” a second time in the on-call window and then clicked-and-dragged to the specimen workflow processing line at a second telepathology step in the process;

FIG. 17 illustrates a queue diagram of a laboratory workup segment of a clinical pathway for breast care showing the on-call window in which a second UPI representing a different individual service provider than in FIG. 11 is displayed on a video monitor along with the multiple copies of the icon representing the first individual service provider;

FIG. 18 illustrates a queue diagram of a laboratory workup segment of a clinical pathway for breast care showing an on-call window in which the UPI representing a second service provider has been clicked-and-dragged into the queue for diagnosing the H & E stained histopathology slides by telepathology;

FIG. 19 illustrates the opening screen of the presentation layer of the command and control system showing examples of data for the service provider (right files) and operational data for a laboratory (left files);

FIG. 20 illustrates the opening screen of the presentation layer of the command and control system for defining an icon showing the current UPI of a service provider with the option of creating a replacement unique personal icon;

FIG. 21 illustrates the screen of the presentation layer of the command and control system that provides the service provider with multiple options with respect to UPI configuration, showing a sampling of plurality of shape options;

FIG. 22 illustrates the screen of the presentation layer of the command and control system that is used by the service provider to initially select or replace his or her UPI;

FIG. 23 illustrates the screen of the presentation layer of the command and control system showing the working model for an updated UPIn. This is the first of a series of define icon screens that are used to fill in the details of the UPI;

FIG. 24 illustrates the computer screen of the presentation layer of the command and control system showing the method for defining the UPI with respect to the pattern of the first component (head) of a UPI;

FIG. 25 illustrates the computer screen of the presentation layer of the command and control system showing the method for defining the icon with respect to the second component (body) of the UPI, In the depicted example, there are three possible employers with defined patterns for the body of the icon;

FIG. 26 illustrates the computer screen of the presentation layer of the command and control system showing the method for defining the icon with respect to the third component (stand) of the individual personalized icon. In the depicted example, there are three possible current locations for the service provider;

FIG. 27 illustrates an example gallery of UPI shapes;

FIG. 28 illustrates an initial computer screen of the presentation layer of the command and control system showing method for an individual service provider to request a case for analysis;

FIG. 29 illustrates a computer screen of the presentation layer of the command and control system in which the individual service provider enters availability for providing services at a specific workload queue by click and drag of a UPI into the workflow;

FIG. 30 illustrates a computer screen of the presentation layer of the command and control system in which the service provider has clicked and dragged his unique personal icon over to the telepathology service queue for a specific clinic. When the button on the mouse moving the icon over the workflow is released, the request is recorded in the command and control system database and reflected in the register of number of providers. The active queue box shows completion of the registration process;

FIG. 31 illustrates a computer screen of the presentation layer of the command and control system illustrating the method for canceling an active request to be a service provider. A right click on “Update Request” activates a pull down a menu that includes the “Cancel Queue” option;

FIG. 32 illustrates a computer screen of the presentation layer of the command and control system following the successful cancellation of a service provider's position in a telepathology service queue;

FIG. 33 illustrates the opening screen of the command and control system for the service provider following the successful login to the command and control system;

FIG. 34 illustrates the presentation layer screen once the service provider or manager has opened their account on the command and control system. In the depicted example, the database is sorted by “Facility” and service providers “On Service”;

FIG. 35 illustrates the presentation layer screen once the service provider or manager has opened their account on the command and control system. In the depicted example, the database is sorted by “Bid” (i.e., charge per case) and service providers “On Service”;

FIG. 36 illustrates a first presentation layer screen that is used to view and modify the distribution of service provides by clinic. Left click on “Modify Clinic Staffing”;

FIG. 37 illustrates a second presentation layer screen that is used to view and modify the distribution of service providers by clinic. Icon delivery boxes are below “active” icon rows;

FIG. 38 illustrates a third example of a presentation layer screen that is used to view and modify the distribution of service providers by clinic;

FIG. 39 illustrates a presentation layer screen that is used to view another distribution of service providers;

FIG. 40 illustrates a presentation layer screen that defines the management view of the command and control system when a “Calendar” tab has been activated;

FIG. 41 illustrates a presentation layer screen that defines service provider availability for telepathology services on a specific day for an individual clinic;

FIG. 42 illustrates a presentation layer screen that tracks the progress in processing a clinical specimen in a laboratory;

FIG. 43 illustrates a presentation layer screen that shows additional progress in processing a clinical specimen in a laboratory;

FIG. 44 illustrates a presentation layer screen used to manage all active clinics within individual practice organizations or all clinics under management;

FIG. 45 illustrates a presentation layer screen that is used to manage the distribution of service providers among various facilities, such as “Clinic A”, “Clinic B”, and “Clinic C” and availability;

FIG. 46 illustrates a presentation layer screen used for the macro management of personnel used to sort service providers according to various parameters such as charges and availability;

FIG. 47 illustrates a presentation layer screen used for the micro management of personnel used to sort service providers according to numbers of cases for defined periods to time;

FIG. 48 illustrates a presentation layer screen used for the macro management of personnel according to numbers of cases for defined periods of time;

FIG. 49 illustrates a presentation layer screen used for the micromanagement of personnel according to numbers of service providers for individual clinics;

FIG. 50 illustrates a presentation layer screen used for the incremental increase in the availability of a service provider in order to handle more cases within a defined period of time;

FIG. 51 illustrates a first example method of operation of a computerized patient care management system in flow chart form;

FIG. 52 illustrates a second example method of operation of a computerized patient care management system in flow chart form; and

FIG. 53 illustrates an example method of implementing various aspects of the present invention.

### DETAILED DESCRIPTION OF THE DRAWINGS

Some of the functional units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, punch card, flash memory, integrated circuits, or other digital processing apparatus memory device.

The schematic flow chart diagrams included are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Telemedicine services benefit hundreds of thousands of patients world wide. Generally, specific types of telemedicine services, such as teleradiology and teledermatology, are used as stand-alone services. This model does not easily accommodate patients who require access to several different categories of medical specialists, especially at smaller institutions lacking a full roster of medical specialists on-site.

Clinical pathways describe the step-wise care of patients with specific medical problems. In order to increase the efficiency of taking patients through clinical pathways at smaller institutions, new service models need to be developed. What is needed especially at smaller institutions is a system and method that will provide coordinated and efficient access of patients to multiple categories of medical specialists. The goal is to have the patient complete multiple steps in clinical pathways within the time frame of a single clinical visit. Rather than the current service model, in which each patient encounter with a specialist or diagnostic service results in the making of an appointment with the next specialist or diagnostic service designated by a clinical pathway for care, panels of specialists or diagnostic service providers would be available to provide services by telemedicine on an “as needed” basis.

The present invention is directed towards a system for monitoring, distributing, and documenting healthcare resources to geographically dispersed patients and providers. The system serves as the information broker between the requester of healthcare diagnostic services and the provider of diagnostic services. The system is comprised of a workflow control module, a business activity monitoring module, a notification module, a workload queuing module, and a scheduling module. The command and control system contains rules engines for the following: provider credentialing, provider scheduling, diagnostic equipment scheduling, clinical documentation routing, provider fee bidding, and additional features. The computerized healthcare management system provides computerized connectivity between the workstations of the providers, patients, administrators, and healthcare support staff.

The system comprising the workflow control module is used for controlling the flow of patients, diagnostic images, and consultations documentation. Utilizing this methodology, clinical workload is dynamically distributed within the network of super efficient multi-specialty clinics.

The system comprising the workflow control module contains an electronic communications infrastructure that provides electronic connectivity of provider workstations and mobile computing devices and the multi-specialty critical pathway clinic network workflow database. Mobile computing devices include, but not limited to, handheld computing devices and cellular telephony.

The workflow control module can contain a method for specialty providers to electronically bid for opportunities to provide clinical consults. This functionality is provided with a customized version of the Cerner Staff Scheduling application. The Staff Scheduling product provides the core scheduling requirements for aligning the appropriate consultant to the service required. The application provides a provider portal for rules-based self scheduling. Administrative views of all schedules are available to those with appropriate system privileges. The Staff Scheduling application provides credential management functionality insuring specialty providers are pre-qualified prior to the assignment of clinical cases. Once credentialed within the system, clinicians are allowed to bid, on an ad hoc basis, for any open cases. The bidding time is limited by the system and can be awarded based on a set fixed-price or lowest bidder. The provider will access the application and view all open cases. He then will select the case for bid and enter a price. Assuming the case criteria was established for “lowest bidder”, the case will be assign to the provider with the lowest bid at the established period of time. Should no one bid on the case, it will be automatically assigned to the standby specialty provider. If the case were assigned the category of “fixed-price”, the first pre-credentialed provider submitting a request will receive the case. Should no requests be received for the “fixed-price”, the case will be assigned automatically to the standby specialty provider.

The application can reside on a hardware platform utilizing an operating system. Application data can be stored on a database. In one embodiment, an interface with existing hospital information systems is provided using the Cerner Open Engine™ Application Gateway Server and the Open Port™ Interface System.

The role of the command and control system in a network of multi-specialty clinics is to serve as the information broker between the requestor of healthcare services and the provider of services. The command and control system will receive requests for services from either the patient or primary care provider. This request will describe the services desired as well as any special consideration, such as urgency. The request is transmitted by the command and control system to the request repository where it is tracked until completed by the provider. Upon initial receipt of the request, the command and control system will determine which network providers meet the criteria defined in the request and have the capacity to fulfill the requirements. It should be noted that the service providers will have previously applied for status as a network provider in the multi-specialty clinic network and have been screened to insure they meet the requirements for that role. The provider has the opportunity to define types of cases and times they will be willing to provide services within this clinic concept.

Additionally, the provider can, on an ad hoc basis, go online with the command and control system and select any cases that are in the pending queue. Once the request has been received and the service provider repository has been queried, a notification is sent to those providers meeting the criteria defined in the request. The network provider choosing to act on this request will reply to the command and control system and the action will be assigned for completion. Upon completion of the service, the results are stored in the results repository and the command and control system notifies the requester. The command and control system will also forward the results to the appropriate electronic health record.

In the healthcare system today, the requester of services is required to seek out providers, one at a time. This greatly constrains the ability to shop for the best value. The implementation of a command and control system allows the requester to post their needs electronically and wait for the network providers to respond. The command and control system provides significant value to the patient and referring healthcare practitioner. From the perspective of the specialty care provider, value is added by the command and control system concept by allowing scheduled and unscheduled open time to be filled with workload from the network.

The command and control system can be made up of multiple modules, operating as hardware, software, or a combination thereof. In one embodiment, the major modules to be used in the command and control system are as follows: The workflow control module can be a hardware, software, or a combination of hardware or software applications that applies the logic for distribution of workload within the plurality of providers. Roles are defined for each provider based on the services being provided and availability of time. The workload is directed to the respective provider when a match occurs between the defined role and the services requested. The workflow control module provides the following: maintains inventory of provider network resources; routes requests for services; receives providers' responses to provide service; assigns workload; and distributes results. In one embodiment, the workflow control module can apply a rules engine to a patient data element stored in the database to monitor the progress of the patient through the clinical pathway as will be further described.

Business activity monitoring software module monitors workload distribution within the plurality of clinical pathway clinics. The business activity monitoring module provides management information on productivity and distribution of workload. Additionally, the business activity monitoring module will monitor the availability of provider resources within the network allowing the clinical pathway clinic management to maintain the network resources needed to meet the services required.

The notification module provides alerts to requesters, provider, and clinic management. Alerts can be in any combination of telephone, mobile phone, routine mail, and email. The method for transmitting the alert will be defined by the provider when joining the network.

The workload queuing module controls the incoming requests and works in conjunction with the workflow control module to insure requests are received and processed in the defined order. The queuing module will note the urgency of the request and insert the request into the appropriate queue.

Under this concept, the scheduling module will work in conjunction with the workflow control module to schedule available resources. This module will interface the appropriate hospital information system and insure the appointments are appropriately documented. As an example, a request for radiology support will be scheduled on the command and control system scheduling module and updated on the provider's Radiology Information System. 18. The system of claim 13, wherein the workflow control module further includes multiple data elements which comprise a super-rapid clinic network encounter record or workflow database.

In one embodiment, the workflow control module can contain an electronic communications infrastructure that provides electronic connectivity of provider workstations and mobile computing devices and a super-rapid clinic network workflow database. The business activity monitoring module can incorporate a component for monitoring the clinic's resources, both equipment and personnel. In addition, the business activity monitoring module can include a method for monitoring and documenting the availability of service providers.

In one embodiment, the notification module includes a subsystem for electronically alerting clinical and administrative personnel, as well as a method for electronically notifying super-rapid clinic network personnel regarding the status of clinical consultations. The notification module can implement a rules engine for determining a method and frequency for personnel notification, as well as implement a method for electronically notifying super-rapid clinical network personnel when pre-established queuing thresholds have been reached or exceeded.

In one embodiment, the workload queuing module includes a subsystem for electronically receiving incoming requests for services and distributing the requests in the appropriate electronic queue. The workload queuing module can implement a method for electronically distributing clinical consultations.

The scheduling module can incorporate a subsystem for electronically scheduling the rapid clinical network personnel and equipment resources, as well as a subsystem for electronically maintaining the schedules for clinicians and diagnostic equipment.

In accordance with the present invention, several interconnected modules, again whether they be hardware, software, or a combination thereof, can implement specific aspects as follows: An enrollment module can be adapted for electronically enrolling the healthcare service provider, or pool of providers, in a provider pool, wherein the enrollment module allows the individual healthcare service provider to generate a computer graphic element including a unique personal icon (UPI) to be used to represent the individual healthcare service provider in presentation layers of the information management system as will be further described.

Additionally, an eligibility module can be adapted for establishing the eligibility for the healthcare service provider, or pool of providers, in the provider pool. A tracking module can be adapted for tracking the level of activity of the individual healthcare service providers, or pool of providers, and tracking the proficiency of the individual healthcare service provider, or pool of providers. Finally, a recording module can be adapted for recording the billing and reimbursement activities of the individual healthcare service provider, or pool of providers.

In one embodiment according to the present invention, the enrollment module enables the individual healthcare provider to generate UPIs based on a standardized format, enables the individual healthcare provider to assemble UPIs that fuse multiple graphically coded identifier features, and enables the individual healthcare provider to mask a personal identity of the individual healthcare provider, although these functions can also be provided by other subsystem components to suit a particular application.

The enrollment module can link the UPI to service provider identification information that is security protected. In addition, the enrollment module can allow the healthcare service provider to electronically transport a version of the UPI belonging to the healthcare service provider.

In one embodiment, the enrollment module can allow the healthcare service provider to electronically transport a copy of the UPI belonging to the healthcare service provider into a presentation layer work flow control screen representing an individual patients clinical pathway. The eligibility module can allow the healthcare service provider to electronically position the UPI into a specific step in a clinical pathway to establish eligibility and availability to perform a specific function in the clinical pathway. The enrollment module can allow the healthcare service provider to electronically clone the healthcare service provider, and the tracking module can monitor self-generated screen-based appointments of the individual healthcare service provider to ensure non-overlap of time commitments and time availability.

As will be further described, each UPI can be archived in a UPI library. In addition, if a healthcare service provider generates a UPI upon enrollment, the generated UPI can then be compared against a master collection of UPIs to ensure that the first UPI is visually unique. If the first UPI is not visually unique, a selection of the first UPI can be blocked and a visually unique substitute can be generated for use as a substitute first UPI by the system.

Notionally, the system architecture will consist of a client interface, command and control system web portal, application server, communications server, and data server. A plurality of data servers can be integrated into a data center, for storing and analyzing data. The command and control system will establish a bi-directional interface between the command and control system and the various information and diagnostic systems utilized by the network providers. Additionally, connectivity will be established between the command and control system and the electronic health record system of the client. The specific architecture will depend on the size and complexity of the clinic and patient population base. The connectivity can be adapted to include capability for transmission of audio, video, or a combination thereof.

The present invention takes into account medical image storage and retrieval issues since medical imaging is crucial in many clinical pathways. Many medical imaging studies, such as digitized mammography and whole slide digital microscopy produce very large electronic files. Use of very large digital image files introduces significant challenges in information technology. The challenges will come in distributing, storing, accessing, securing, and archiving these images. Several information technology concepts will come into play in solving the problem. Grid computing, parallel computing, and distributed computing are a few of these concepts.

The structure of the present invention and its efficacy have been tested between two healthcare organizations in Tucson, Ariz., and yielded impressive results. In a clinical setting, deployment of certain aspects of the present invention designed to test the approach described and developed in detail above, turn around times for patients with mammography studies necessitating a biopsy were greatly reduced. Instead of waiting one to two weeks for biopsy results, patients came to a clinic in a hospital, had core biopsies of breast tissue, the tissue was rapidly processed in the laboratory and the histopathology slides read out by telepathology, by a pathologist physically located at another hospital, and the patient consulted of the results by an oncologist at another hospital by video conferencing, in four hours or less. This greatly reduced the apprehension of the patient who would have otherwise waited weeks to complete the clinical pathway, reduced costs by consolidating clinic visits, and increased patient compliance since the possibility of being lost to follow-up was minimized.

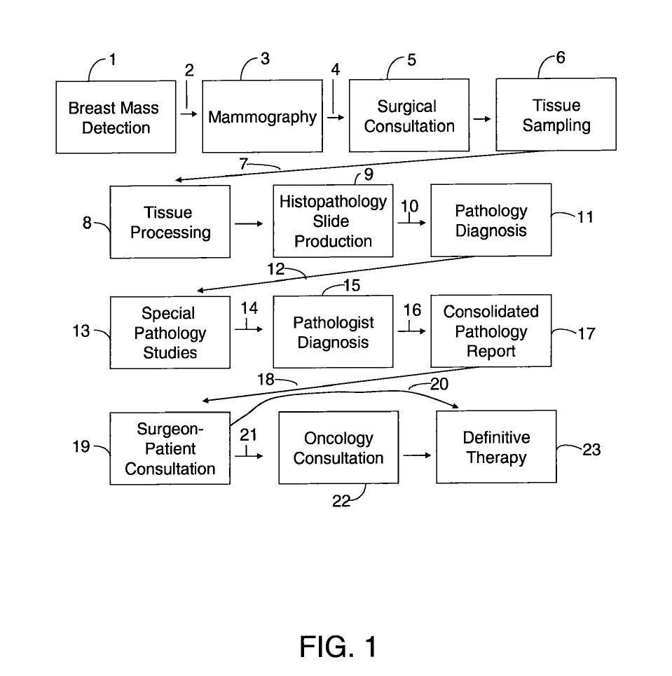

Referring to FIG. 1, a flow diagram shows the important steps in the management of patients with a breast mass. The patient may detect a mass 1 on self-examination and may self refer to a mammography imaging center 2 where imaging is carried out 3. The results may be forwarded to a primary care physician or a surgeon 4. The surgeon 5 or the radiologist-mammography reader may sample the breast mass 6 one of several ways, such as, by performing a core biopsy or a fine needle aspirate biopsy of the mass. The tissue is fixed in formalin and/or by microwave and the transported 7 to a pathology laboratory 8 for processing into paraffin-embedded tissue blocks.

In the histopathology laboratory 9, the tissue blocks are sectioned by a laboratory technician using a microtome, mounted on a glass slide, and stained, typically with hematoxylin and eosin, and the section on the glass slide is cover-slipped. The stained slide(s) is the then transported 10 to a pathologist who examines the slide(s) by light microscopy, or from a remote location by telepathology, and renders a benign or malignant diagnosis 11. If the tissue slide shows breast cancer, the pathologist may order special laboratory studies 12, to be carried out by having histopathology laboratory 8, 9 cut additional paraffin sections, stain them with methods specific for quantitating cell molecules of diagnostic and/or prognostic importance 13 such as estrogen receptor molecules, progesterone receptor molecules, Ki67, or Her2/NEU. Slides prepared with special specific stains are then transported to a pathologist 14 who analyzes the slides 15 and generates a report. Typically, the pathology will 16 examine the results of the initial hemotoxglin and eosin stained slides 11 along with the special studies slide analysis 13, integrate the results 17 and generate a consolidated pathology report including both sets of pathology slide analyses 12.

The pathology report is sent to the physician who performed the tissue sampling biopsy 18, such as a surgeon. The surgeon may carry out additional examinations and provide the patient with treatment options 19 such as a lumpectomy or a mastectomy, and/or refer the patient to an oncologist 22 and/or radiotherapist for definitive therapy 23. This flow diagram describes a few of a number of clinical pathways or patient options, and is not inclusive, but is shown by way of example.

Patients in many clinical settings experience elapsed times from the detection of a breast mass by self-examination, physician examination, or by mammography 3 to the time of a surgeon-patient consultation 19 or oncology consultation 22 of twenty one to thirty days, which is currently regarded as the standard-of-care for breast disease in the medical community. Unfortunately, this is suboptimal for a number of reasons, including patient inconvenience from being required to make many physician appointments and be seen by multiple physicians at different days and at different geographic locations, the added expense of multiple days of lost work, and the personal distress that patients experience waiting for a diagnosis.

One embodiment of the present invention describes a process and method for minimizing the time it takes for a patient to complete a clinical pathology for the identification and diagnosis of breast cancer including mammography, tissue biopsy, biopsy readout by a pathologist, special immunohistochemical and in situ hybridization laboratory studies of the tissue biopsy with pathologist diagnoses, and when warranted initial patient consultation with an oncologist. The method and process allows for a patient to start and complete a breast disease clinical pathway at a single geographic location, without leaving the site, in a single day.

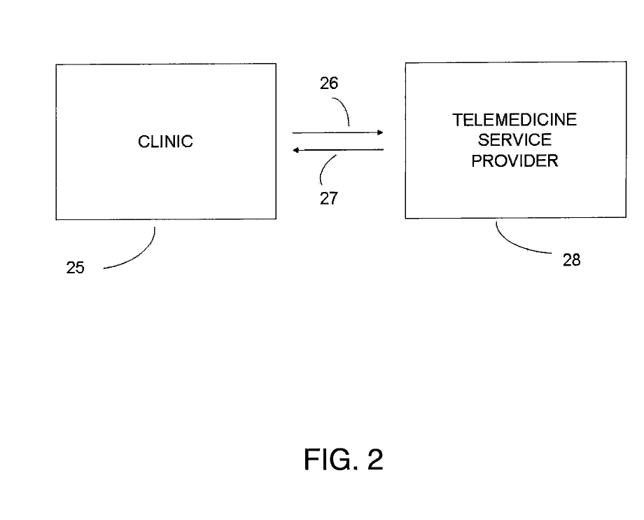

Referring to FIG. 2, telemedicine is used to provide a patient, for example at a clinic 25, to have access to a healthcare service provider 26, 27 at a different physical location 28. Currently, many different professional services, including medical services such as access to an oncologist, consultation with a surgeon or surgical follow-up, radiologist diagnostic services (i.e., teleradiology), and pathology diagnostic services (i.e., telepathology) can be provided on a remote basis from a geographically distant physical location. Video, audio, and data information can be transmitted by telecommunications, from the clinic to the service provider 26 or from the telemedicine service provider 28 to the clinic 27. A plurality of medical professionals can be thus engaged by the patient.

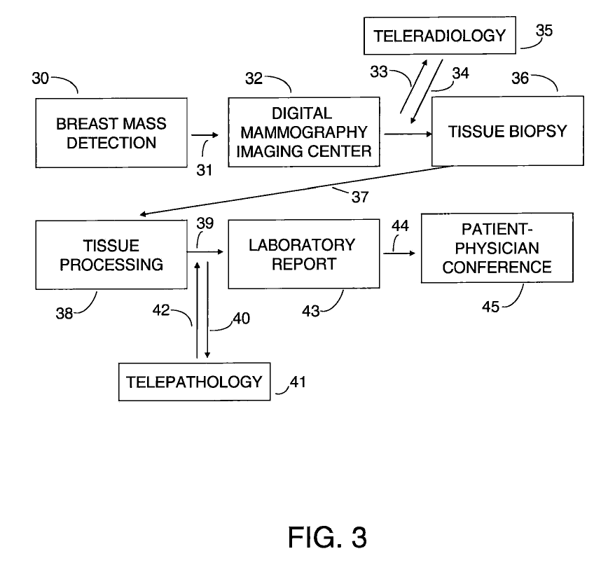

Referring to FIG. 3, telemedicine can reduce the elapsed time that it takes for a patient to move through events, or steps, in a clinical pathway. For example, following detection of a breast mass by self-examination or mammography 30, a digital mammography exam can be scheduled 31 and performed, for example, at a breast center, imaging center, or surgicenter 32. The electronic file of the digital mammography study can be transmitted over a telecommunications linkage to a teleradiology reading center 35 and read out immediately. The results of the radiologist report are transmitted back to the clinical site 34, 35 where the patient awaits the report, with her physician. In certain clinical situations, a tissue biopsy may be carried out immediately 36. The biopsy specimen is transported to an onsite laboratory equipped to do ultra-rapid tissue processing 37. The onsite laboratory is equipped to process tissue biopsies, including the production of glass histopathology slides in less than two hours 38, while the patient remains at the clinic awaiting the results. This is accomplished using a combination of microwave and rapid embedding.

After histopathology slides are prepared, they can be diagnosed by a pathologist 39, either on-site or by remote diagnoses using telepathology 41. For telepathology, images of histopathology glass slides, or cytopathology glass slides, are sent by telecommunications to a telepathogist 40 at another location. The slide(s) are viewed on a video monitor and diagnosed from a distant site 40, 42. A consolidate laboratory report is generated 43, either on-site at the clinic or at on off-site service center. The results of the off-site telehealth (telemedicine) services and the on-site services are then communicated to the patient who is a the clinic where the mammography imaging and, when needed, the surgical biopsy have been performed 30, 32. The total elapsed time from the time of breast mass detection 30 to the time of the patient-physician conference 45 can be reduced from days, for patients without access to a full range of physician specialists at one physical location, to under eight hours, by bringing coordinated specialty services to patients by telemedicine, telepathology, teleradiology, and teleoncology. The interaction between the physician and the patient 45 can be by a face-to-face encounter or with the patient at one physical location, the clinic or hospital, and the patient either in the same room or by interacting with the patient using bi-directional video conferencing.

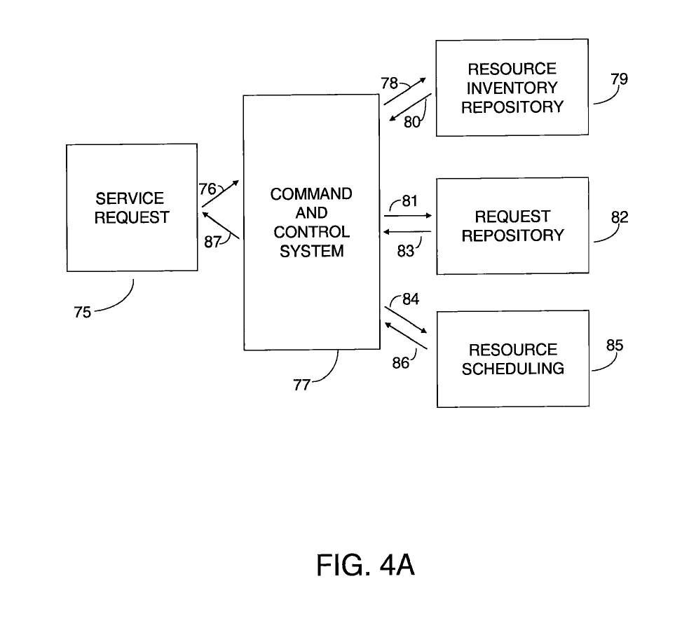

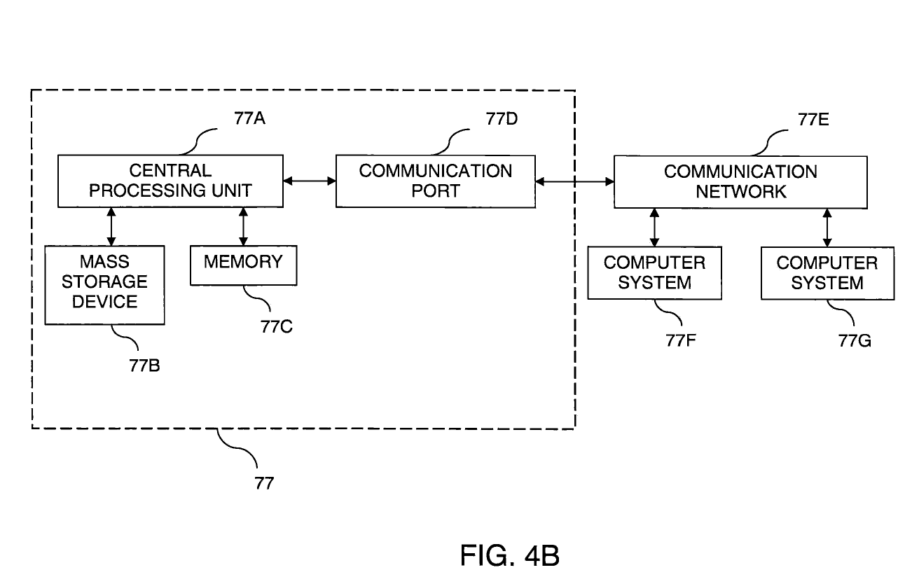

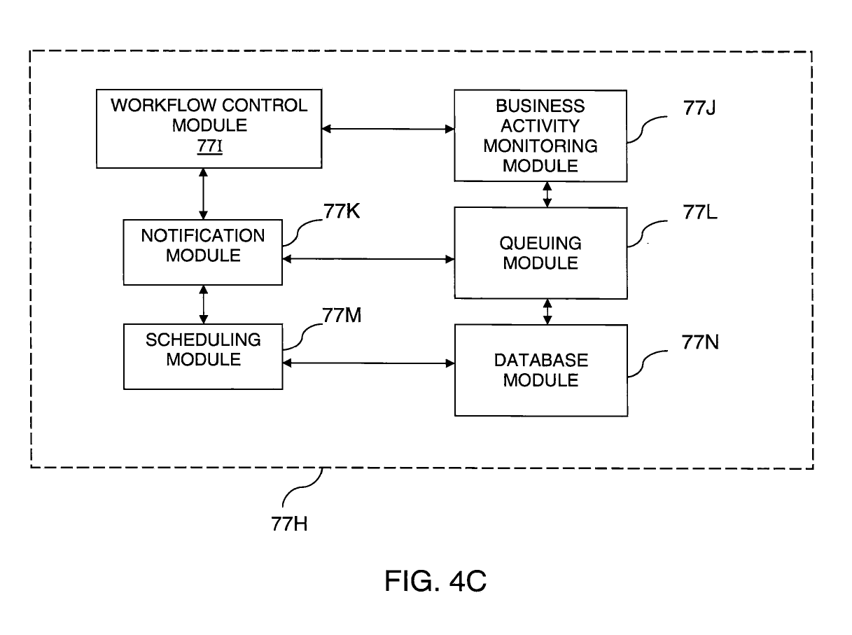

Referring to FIG. 3 and FIG. 4A, scheduling and service tasks will be achieved with maximum efficiency by time-sharing the services of many different individuals with special skills. Efficiencies are achieved by combining point-of-care services, such as digital mammography imaging 32 and tissue biopsy 36 with remote off-site readouts for diagnoses by teleradiology 35 and telepathology 41. Efficiencies of scale can be achieved by aggregating decentralized clinic sites, where patients are physically located, into a network, linked by telecommunications. Workflow is managed with a command and control system. The network will provide a distributed computing environment.

A request for a telemedicine services, such as teleradiology or telepathology will originate at one of the clinics where a patient is physically located 75. The request can be electronically forwarded to the command and control system 76, 77. The command and control system can send information to 78 and query the resource inventory repository 79, 80. The command and control system and send information to 81, and receive relevant information from, the request repository. And, the command and controls system can send information to 84 and receive information from the resource scheduling database. The resource inventory repository 79 will store, maintain and update many categories of information including service provider rosters and schedules indicating individual service provider's availability to provide services, and information on clinic site-specific physician credentialing and licensure. The request repository tracks service requests from a plurality of decentralized clinics in a large geographic area. Databases on service requests for teleradiology, telepathology, teleoncology, and other telehealth services are maintained and immediately updated when a relevant event occurs. At the request repository 82, service provider availability may be matched with the resource inventory 79 information, as part of the database maintenance and updating processes, or this collation may be carried out by the command and control system 77. Resources scheduling may set availability work lists taking into account a multiplicity of factors such as service provider expertise, service provider proficiency, service provider contractual obligations as well as service user preferences, priorities, and many other potential selection factors. The resources of a variety of services of medical professionals, such as general practice telephysicians, but also including various telemedicine, teleoncology, teleradiology, telepathology, and other teleconsultants can be incorporated into command and control system as will be further described. In one embodiment of the present invention, each of the geographically dispersed telephysicians can individually serve as teleconsultants.

FIG. 4B illustrates an example plurality of computer systems which can be incorporated into a command and control system 77 illustrated in FIG. 4A. As previously mentioned, the present invention incorporates a series of modules and applications which are intended to execute on a computer system and operate over a variety of networks. To accomplish this functionality, one or more central processing units 77A are shown connected by a signal bearing medium to mass storage device(s) 77B which can include hard disk drives (HDDs) or similar storage components. Additionally, CPU(s) 77A are coupled to a memory device(s) 77C which can include electrically erasable programmable read only memory (EEPROM) or a host of related storage devices. CPU(s) 77A can be connected to a monitor device (not shown), providing a graphical user interface (GUI) to a user of the command and control system 77 for display of a UPI, for example.

A communication port is shown coupled to CPU 77A, which provides an outside interface to a communication network 77E which can include local area network (LAN) segments, wide area network (WAN) segments, a combination of LANs and/or WANs, and incorporate a variety of communications protocols and technologies, such as standard telecommunications linkages, or wireless IEEE 802.11 in a variety of forms. Computer systems 77F and 77G can also assist command and control system 77 in gathering, storing, or disseminating data from remote to local locations and vice versa. Systems 77F and 77G can include similar subcomponents as previously described, or incorporate additional technologies as needed for a particular application.

FIG. 4C illustrates an example block diagram of modules which can be configured to operate in conjunction with CPU 77H as depicted. As would be understood by one skilled in the art, however, the depicted example modules can be configured as hardware, software, firmware, or a combination of the foregoing to be operational on a computer system 77 in an overall command and control system 77.

As previously described, one embodiment of the present invention incorporates such depicted interconnected modules as a workflow control module 77I, a business activity monitoring module 77J, a notification module 77K, a queuing module 77L, and a scheduling module 77M. In addition, an embodiment may incorporate a structure or architecture which can be designated a database module 77N, where a plurality of data can be stored, organized, and retrieved in association with mass storage device(s) 77B or elsewhere. Again, as previously noted, the foregoing modules can implement varying aspects of the present invention according to a particular embodiment.

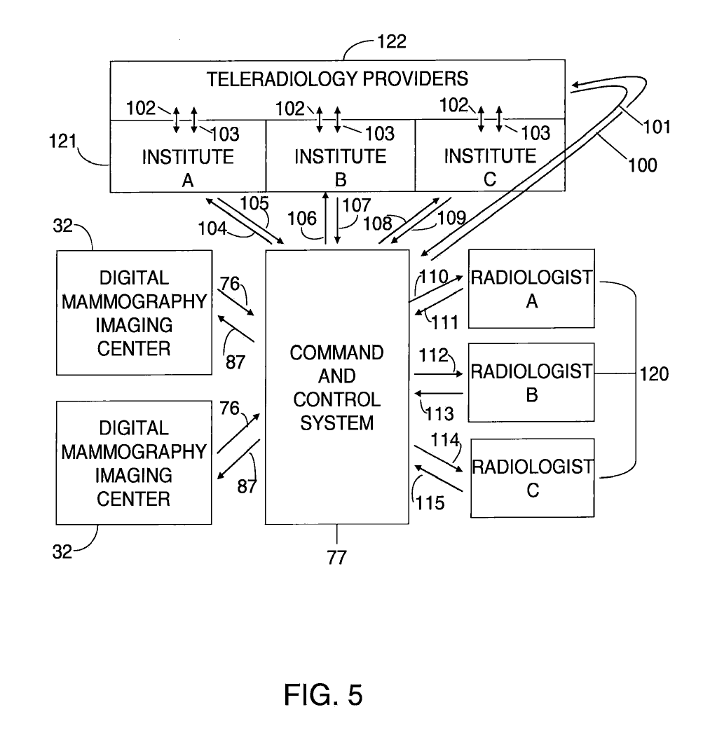

Referring to FIG. 3, FIG. 4B, and FIG. 5, one, or a plurality of clinics 32 doing digital mammography, but without an on-site radiologist-mammographer can notify the command and control system of the request for read out services. There are a number of different categories of service providers. Individual teleradiologists 120 may be on the roster of teleradiologists (i.e., radiologists who render diagnoses at a distance over telecommunications linkages) 110, 111, 112, 113, 114, 115. Institutes of imaging, or call centers 121, may aggregate teleradioloists on their staffs and provide teleradiologists, as needed, from their own on-call rosters, over telecommunications linkages which link their institutions 104, 105, 106, 107, 108, 109 to the command and control system. Alternatively, new organizations of teleradiology service providers 122 may aggregate imaging institutes 121 into “virtual group practices” and/or individual radiologists 120 into “virtual group practices” to provide rosters of case readers eligible to diagnose cases based upon their availability or other criteria. Teleradiology work rosters will be assembled from information on teleradiology at the resource inventory repository 79. Such providers 122 can have computer systems 77F or 77G which are connected through communication network 77E to the command and control system 77.

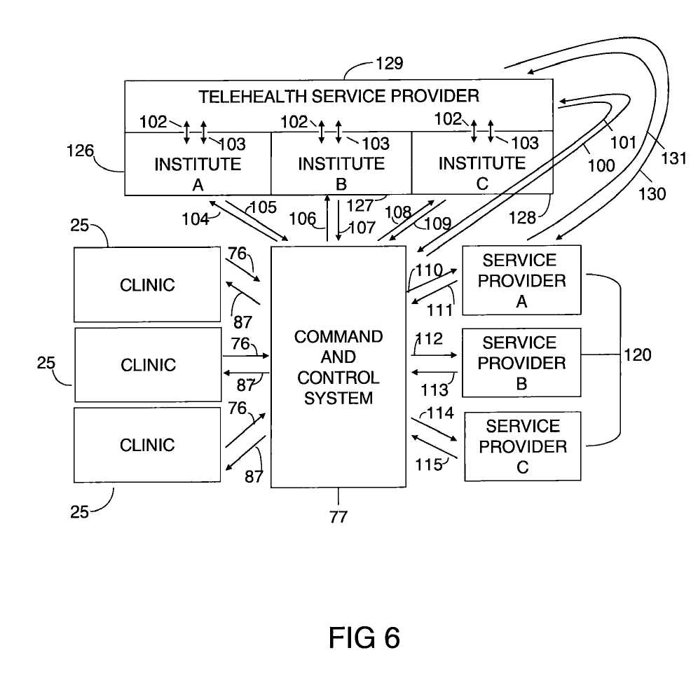

Referring to FIG. 6, one, or a plurality of clinics 25, which may or may not incorporate a digital mammography imaging center 32, but/and without the fully range of medical specialists needed for a patient to complete part, or all, of a clinical pathway, (see FIG. 1), can obtain these services off-site by telemedicine. The clinic 25 staff can notify the command and control system of the telestaffing requirements. These services may be drawn from one of a number of sources by the command and control system coordinating process. For example, individual service providers may contract to be service providers 125. Telemedicine institutes 126, 127, 128 may have a plurality of service providers, representing one or a plurality of specialties, such as pathology and oncology, on staff and available to provide teleconsultations. “Virtual” telehealthcare organization 129 may aggregate individual service providers 125 linked by telecommunications 130, 131 to the “virtual” telehealth organization, and to telehealth institutes 126, 127, 128 into larger health service provider organization. The telehealth service provider organization 129 can broker services via the command and control system 77 to one or a plurality of clinics 25.

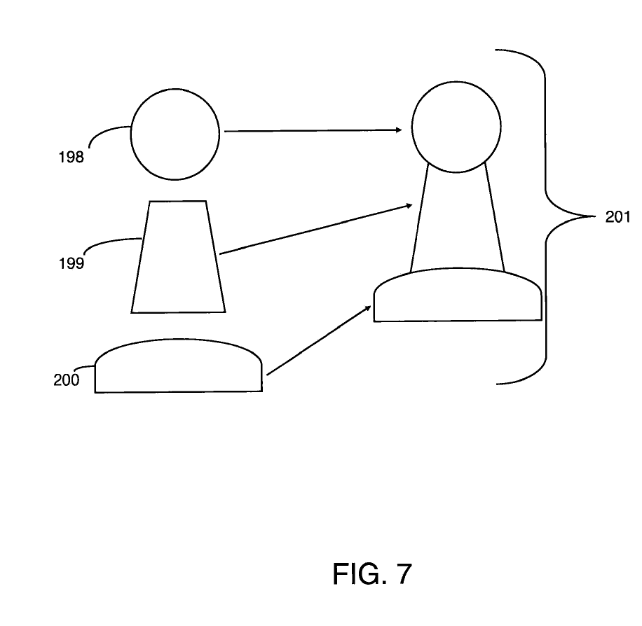

Referring to FIG. 7, individual consultants are represented as object icons in the command and control system. Visual representations of icons in workflows and workforce control operations has the advantage of efficiency and creates and important tool for allocating cases and matching service opportunities with the workforce. FIG. 7 shows a protocol individual personalized icon. This three piece icon consists of three independent components, a head 198, a body 199, and a stand 200. Other versions can also exist such as four and five component icons. Icon components are electronically assembled into a complete UPI 201 which represents an object.

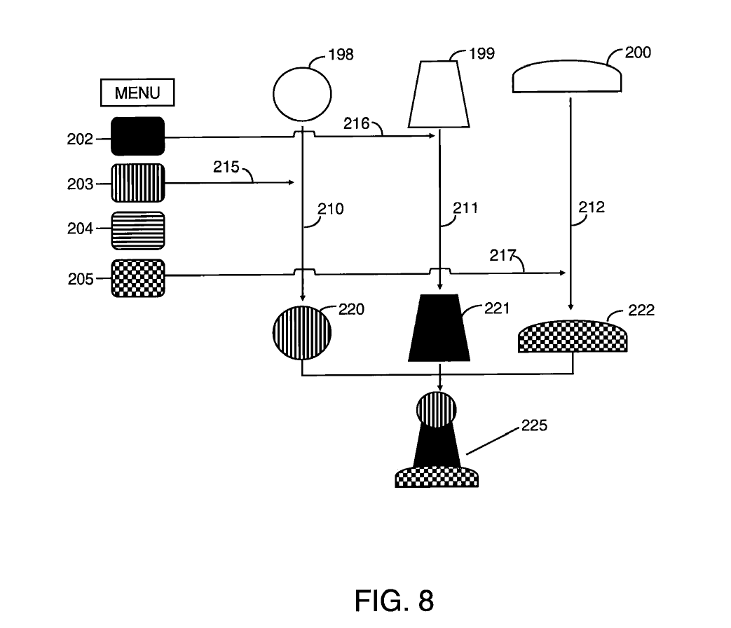

Referring to FIG. 8, individual personalized icons are assembled from color and pattern options drawn from a menu. In this example, the menu provides four options, a solid black option 202, a vertical stripe option 203, a horizontal stripe option 204, and a checked option 205. In this example the vertical strip option 203 is click and dragged 215 to the top piece 198 to create a vertical striped top piece 220. The solid black option is click and dragged 216 to the middle piece 221. The check pattern 205 is click and dragged 217 to bottom piece 222. The three objects are then assembled electronically into an individual personalized icon which can be used to track the service provider's activities as managed by command and control system presentation screens.

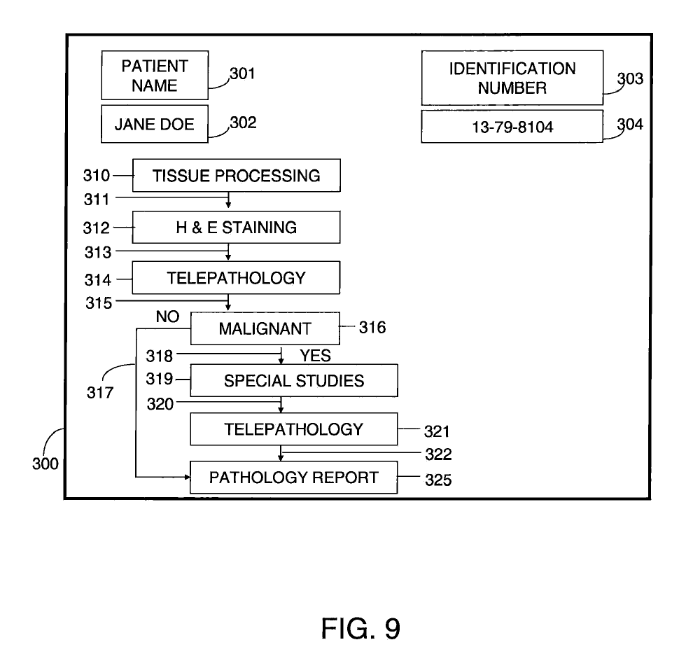

Referring to FIG. 9, an example GUI computer screen 300 shows patient information 301 including an individual patient's name 302, and the patient identification number 303, 304. On the left is a flow diagram of the laboratory segment of a clinical pathway for a patient being worked up for breast disease. The steps include tissue processing 310, the cutting of histopathology sections 311, Hematoxylin and Eosin (H&E) staining of the tissue sections 312, transfer of the slides to virtual slide processor 313 or other telepathology microscope, diagnosing the slide by a pathologist at a distance over a telecommunication linkage by telepathology 314, and the rendering of a benign or malignant decision by the telepathologist 316. If the tissue is benign (i.e., not malignant) then a pathology report is generated 317, 325. If the biopsy shows malignancy, the special histopathology studies 319 are carried out and the additional histopathology slides are scanned by a virtual slide processor 320, posted on a server, and diagnosed using a browser by telepathology 321. The results are forwarded electronically to a service center where a consolidated pathology report is generated 325.

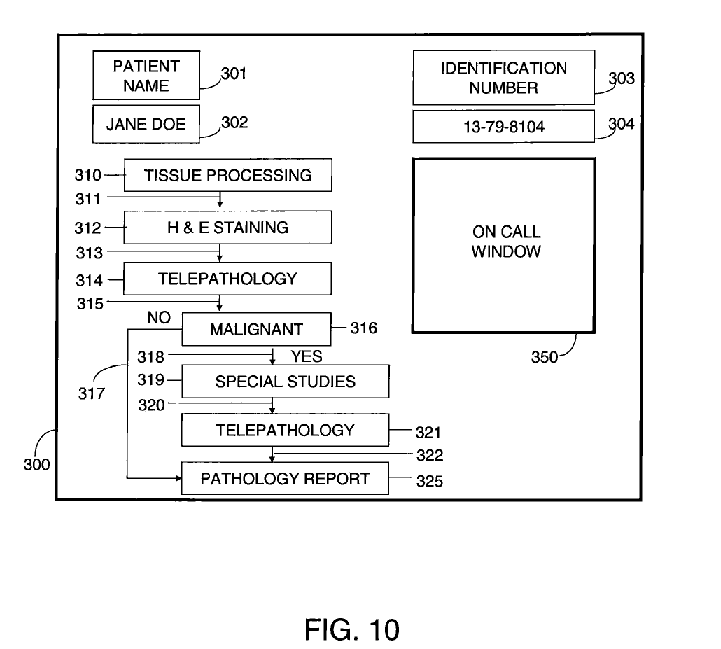

Referring to FIG. 10, a computer screen, 300 is illustrated as in FIG. 9, to which an on call window 350 has been added. This window is used as a presentation screen-based staging area for deployment of individualized personal icons (iPi) into the work flow, 310-325.

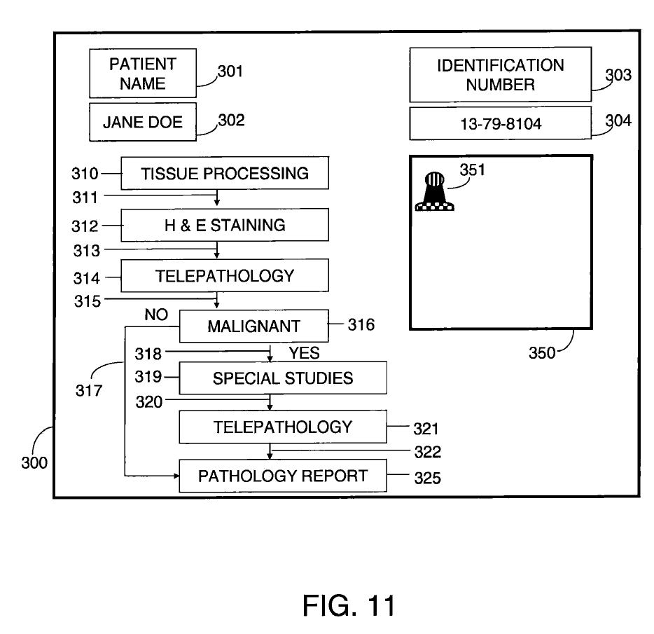

Referring to FIG. 11, a computer screen 300 is again illustrated as in FIG. 10, on which an individual personalized icon 351 has been added electronically to the on call window. In one embodiment, this icon 351 can be clicked-and-dragged to the assembly line work flow illustrated on the left side of the presentation screen.

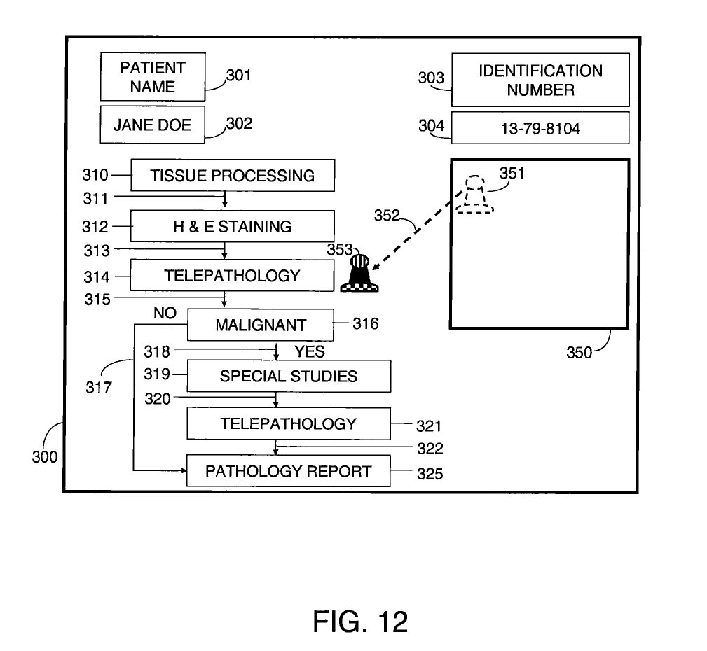

Referring to FIG. 12, a computer screen 300 is illustrated as in FIG. 11 which shows a individual personalized icon 351, representing an individual service provider, being clicked-and-dragged 352, 353 over to a telepathology step 314 in the workflow. The act places the service provider at the head of a queue to diagnose the next telepathology case that comes through the laboratory clinical pathway.

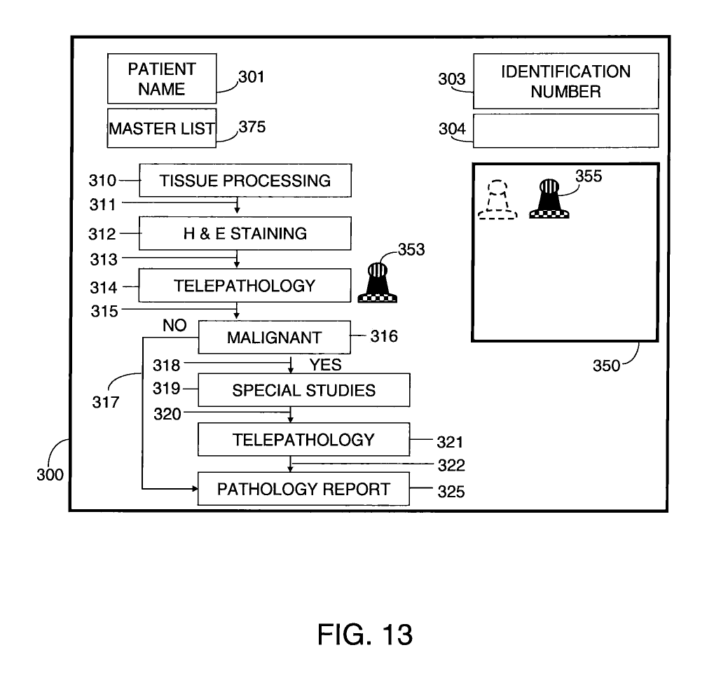

Referring to FIG. 13, the computer screen is illustrated as in FIG. 12, depicting a second individual personalized icon 355 entered into the on call window.

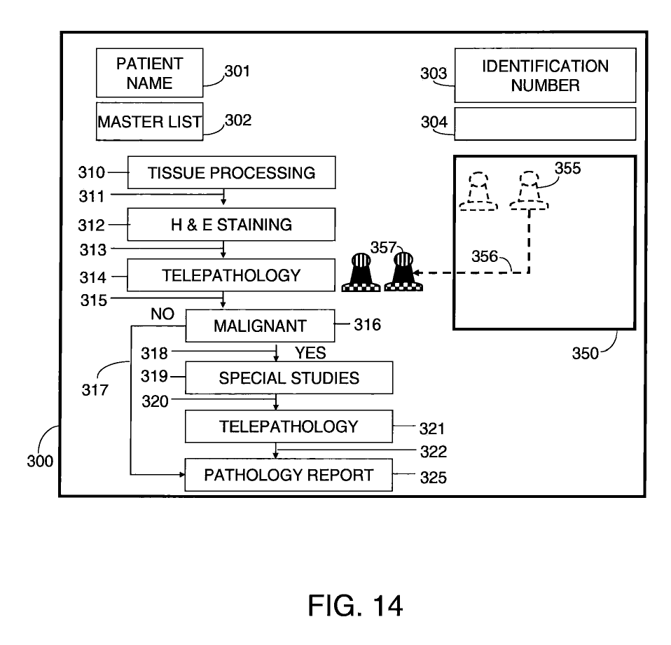

Referring to FIG. 14, the computer screen is illustrated as in FIG. 13, depicting the process of click-and dragging 356 an icon 355 into the queue 357 for providing a telepathology diagnoses 315.

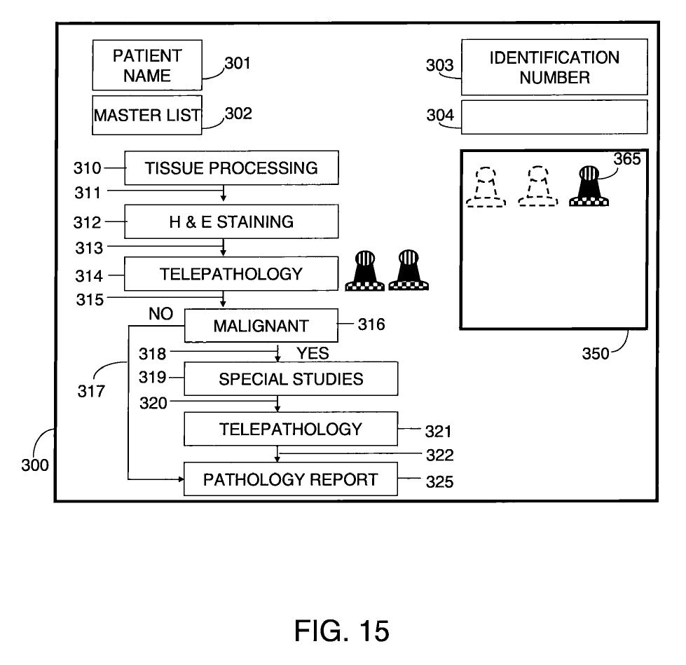

Referring to FIG. 15, the computer screen is illustrated as in FIG. 14, depicting the addition of a second individual personalized icon 365 to the on call window, representing the same service provider as before.

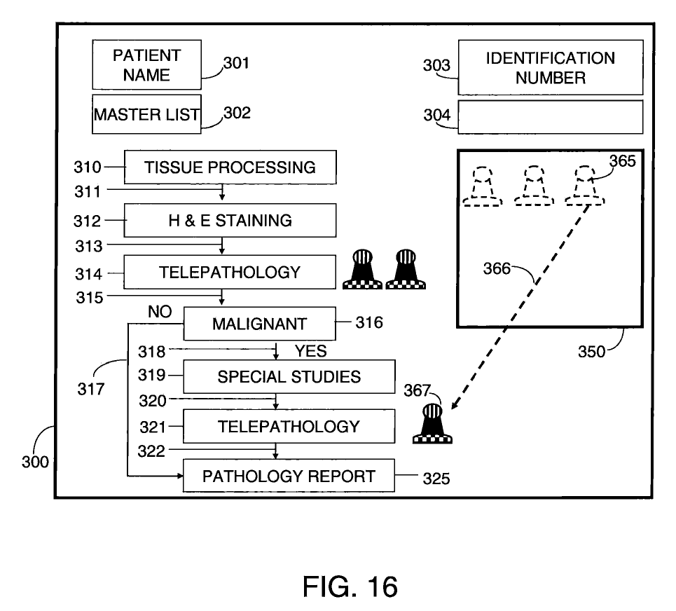

Referring to FIG. 16, the computer screen is illustrated as in FIG. 15, showing the click and drag of the third individual personalized icon, 365 representing the same service provider as before, being moved to a second telepathology service queue 321.

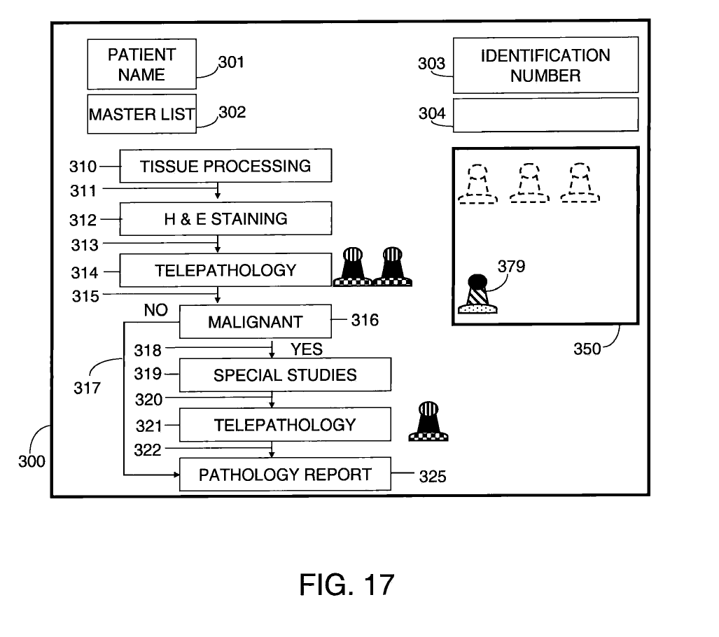

Referring to FIG. 17, the computer screen is illustrated as in FIG. 16, showing the addition of an individual personalized icon representing a second individual personalized icon 379 to the on call window.

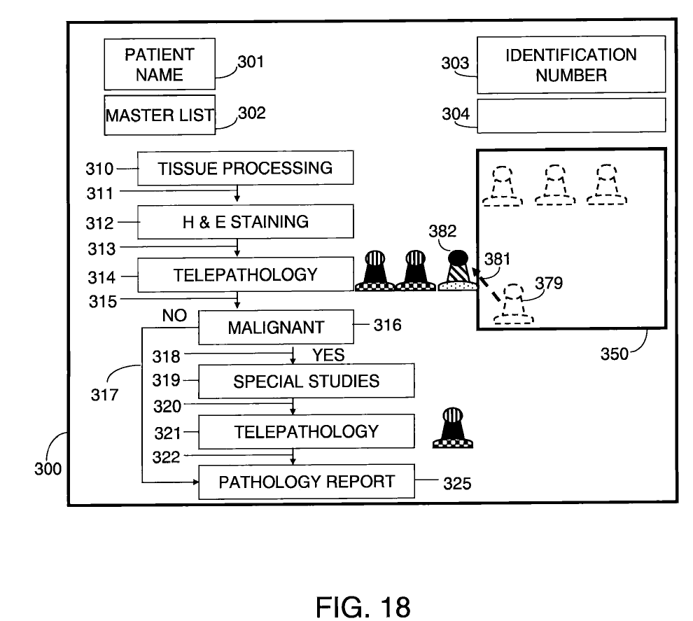

Referring to FIG. 18, the presentation computer screen is illustrated as in FIG. 17, showing the click and drag 381 of the second individual personalized icon 379 to the third position in the telepathology queue 314.

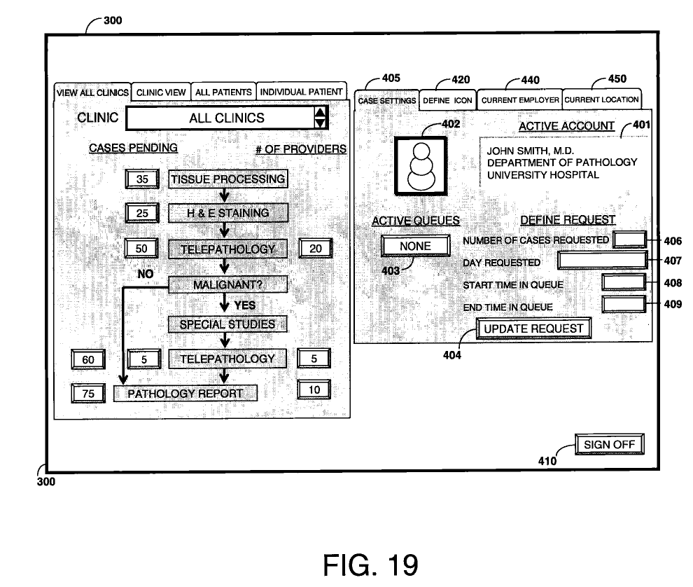

Referring to FIG. 19, a computer program presentation layer as viewed by the provider following a success login to the system is depicted. The video monitor screen 300 shows the stack of files related to clinics and patients and the stack of files on the right represents service providers with information on case settings 405, tools for self-generation of a unique personalized icon 420, information on current employer 440 and current location 450. The individual active account 401 and current unique personalized icon 420 are displayed. An individuals registrations in active queues 403 can be displayed as a pull down menu. The individual service provider can enter a request for cases 406 on a specific day 407 within a specific time frame with respect to start 408 and finish 409 times. The request form can be updated 404 and the requester and sign off 410 at any time.

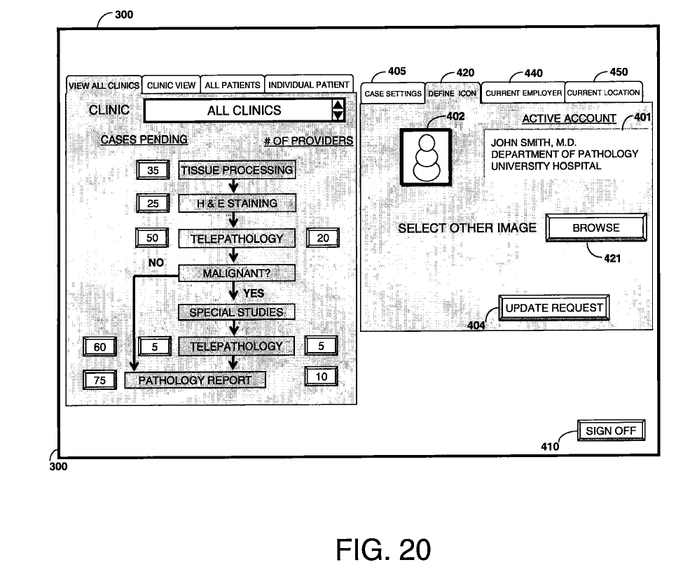

Referring to FIG. 20, the computer program presentation layer on a video monitor 300 shown in FIG. 19 is again seen and shows provider's selection of the “Define Icon” tab 420 on the right side screen panel. This screen allows providers to customize their icons. The “New Icon” selection button activated from the browse button 421 allows further customization of the icon by activating an additional table of icons.

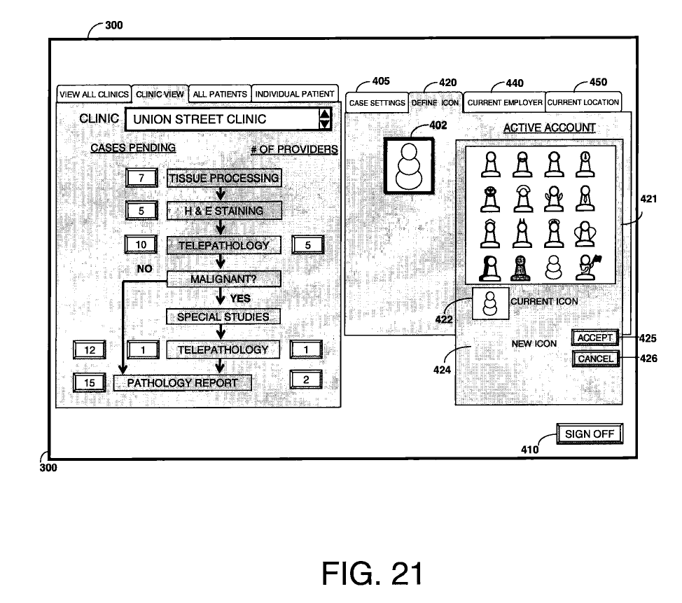

Referring to FIG. 21, the computer program presentation layer depicted in FIG. 20 is again seen, showing the selection process for a customized icon shape. The present figure shows the current icon for medical professional John Smith, M. D. in FIG. 20 in box 402 and 422 and a selection of alternative icon shapes 421.

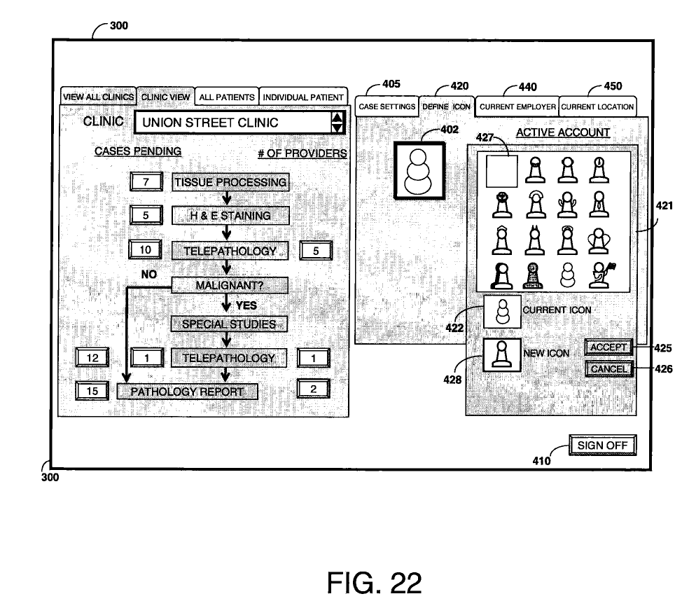

Referring to FIG. 22, the computer program presentation layer depicted in FIG. 21 is again seen, showing that the user has selected a new icon by clicking on an icon 427 in the menu of icon shapes. The selected icon appears in a new icon box 428. At this point the user can accept 425 or cancel 426 this action by clicking on the respective action button.

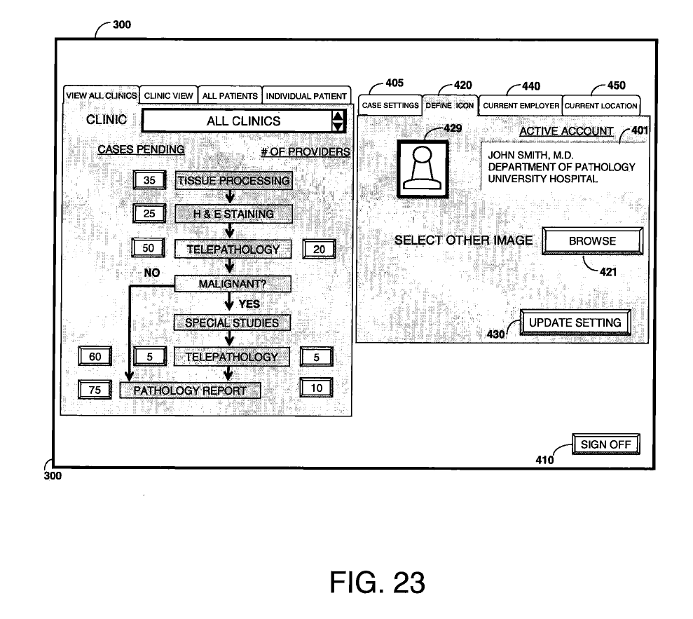

Referring to FIG. 23, the computer program presentation layer depicted in FIG. 22 is again seen, showing a resulting screen once the user has accepted the new icon shape 429.

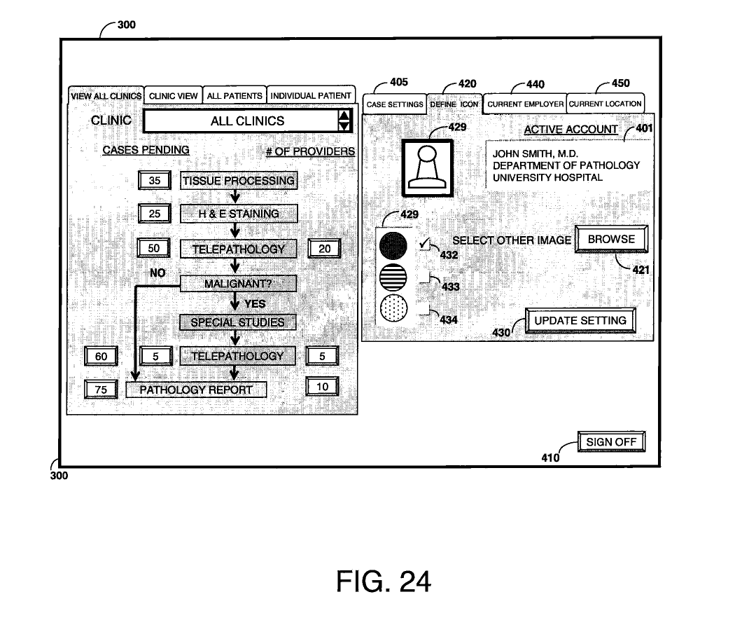

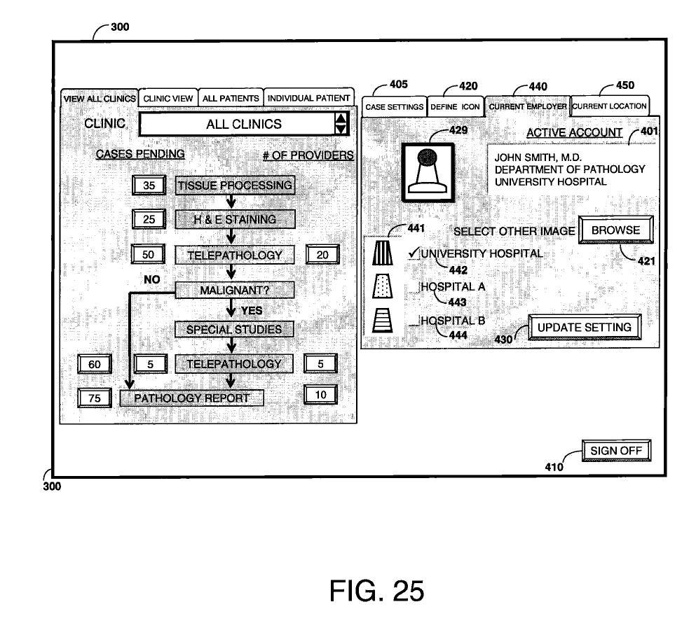

Referring to FIG. 24, the computer program presentation layer depicted in FIG. 23 is again seen, showing a next step for the provider to create a unique personal icon. This is done by selecting a unique pattern for the icon “head” 429. The provider checks the appropriate box 432 and the screen is refreshed with the selected icon representation (See FIG. 25) 429.

Referring to FIG. 25, the computer program presentation layer as seen in FIG. 24 is again depicted, and is used to further customize the unique personal icon 429 by either by selecting a pattern and color for the icon “body” from pattern menus and color palates 441 or by using pre-defined patterns and colors representing a specific facts such as current employer 442, 443, or 444. The icon is updated using the update setting button 430.

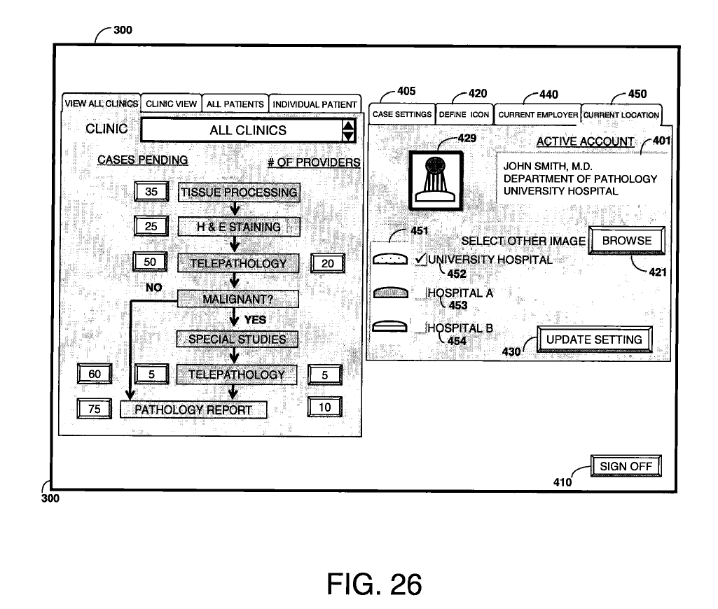

Referring to FIG. 26, the computer program presentation layer depicted in FIG. 25 is again seen, here used to further customize the unique personal icon 429 by either by selecting a pattern and color for the icon “body” from pattern menus and color palates or by using pre-defined patterns and colors representing a specific facts such as current location 452, 453, or 454. The icon is updated using the update setting button 430.

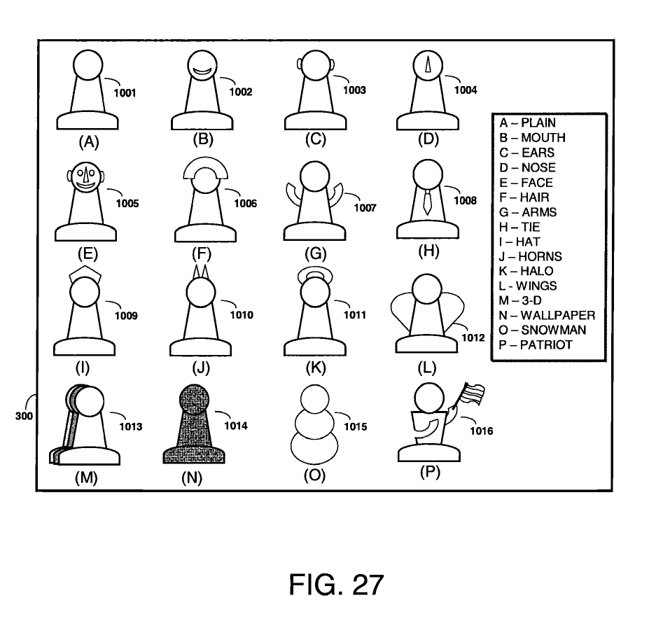

Referring to FIG. 27, a gallery representing a sub-set of icon shapes out of millions of possible shapes that can be computer generate, is depicted. The shapes have multiple compartments that can be independently designed. Features such as hair 1006, arms 1007. or wings 1012 can be custom colored and patterned expanding further the range of designs for unique personal icons. The flag of the patriot 1016 may be used to identify nationality, corporate identity, organization, or another special identifier for sub-groups of individuals.

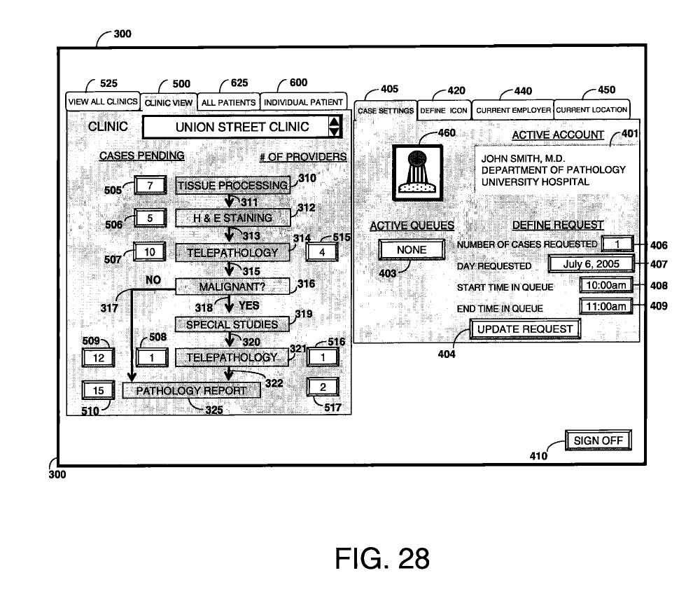

Referring to FIG. 28, the computer program presentation layer depicted in FIG. 19 is shown, and depicts the process for requesting entry into the command and control queue. The provider enters the screen defined information and clicks on the “Update Request” action button 404 in the lower right panel. The provider then clicks and drags the newly defined icon 460 into the desired workload block 500.

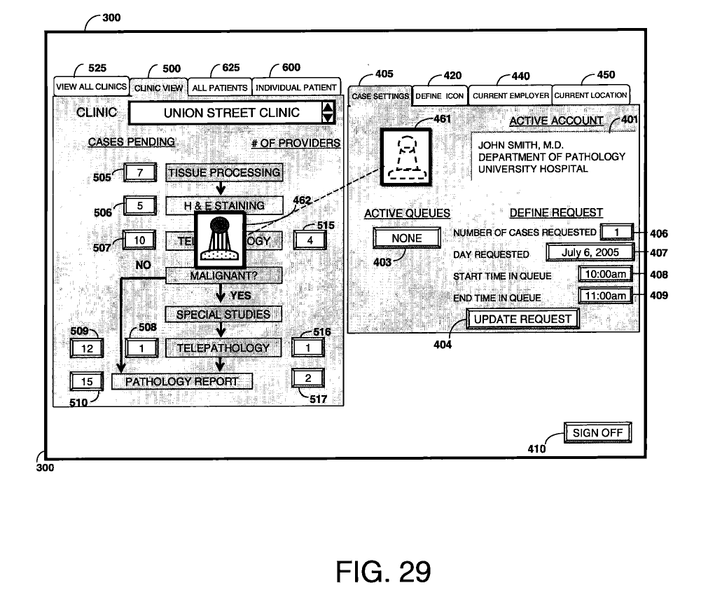

Referring to FIG. 29, the computer program presentation layer on a video screen 300 as in FIG. 28 is again depicted, and shows that Dr. Smith has requested to be in the “Telepathology” queue 507 at the Union Street Clinic by click and drag 462 of the unique personal icon 461. Once the icon is released, the request is recorded in the command and control system database 515.

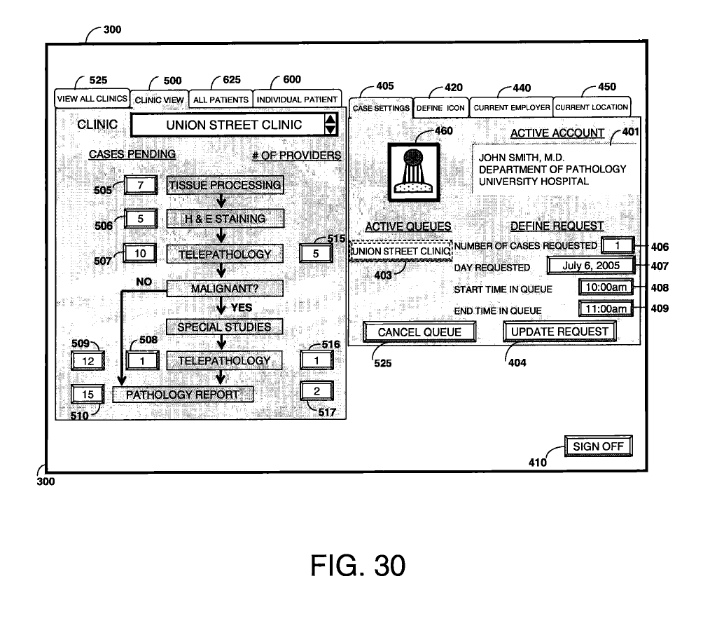

FIG. 30 shows the computer program presentation layer as seen in FIG. 29 and illustrates the presentation layer immediately following the completed request. The noted changes to the screen are as follows:
1) # of Providers in the Telepathology block has increased from 4 to 5 showing Dr. Smith is now in the queue.
2) An update has been made to the Active Queues field 403 in the right panel. This update shows the date 407 and time 408, 409 for the active request.
3) The Cancel Queue button 525 becomes visible in the lower left of the right panel.
   The request remains active until a case is assigned and completed or cancelled 404 by the service provider.

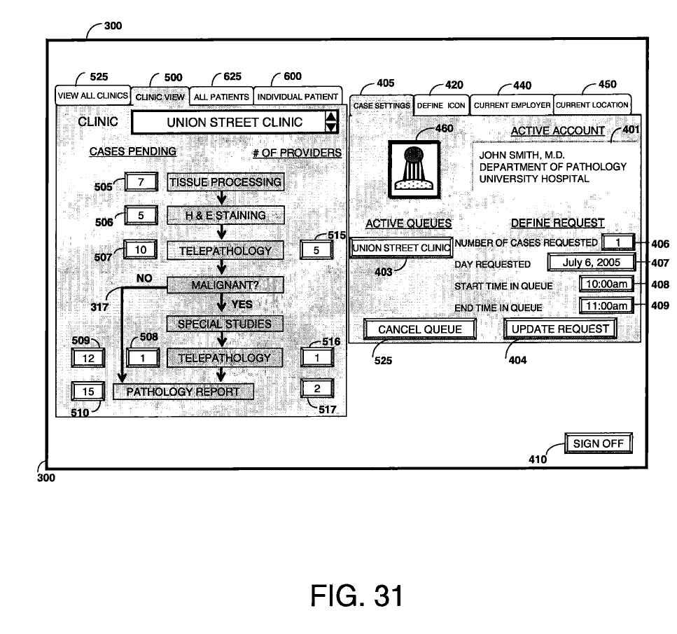

Referring to FIG. 31, this shows the computer program presentation layer as seen in FIG. 30 is again seen, showing the process for canceling an active request. The provider selects the queue to be canceled by clicking on the respective active queue line. Once selected, the provider then clicks on the Cancel Queue button 525.

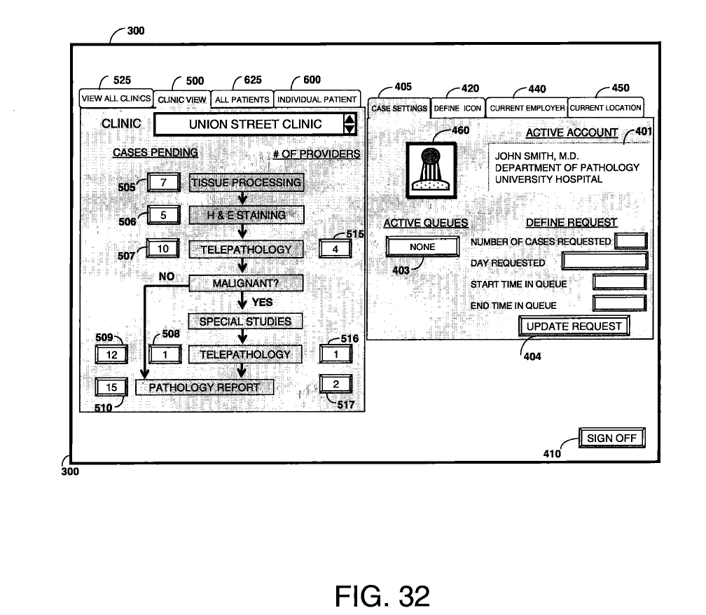

Referring to FIG. 32, this shows the computer program presentation layer as in FIG. 31 and shows the presentation layer following a successful request cancellation. The active queue line has been removed and the Telepathology provider number 515 has been readjusted.

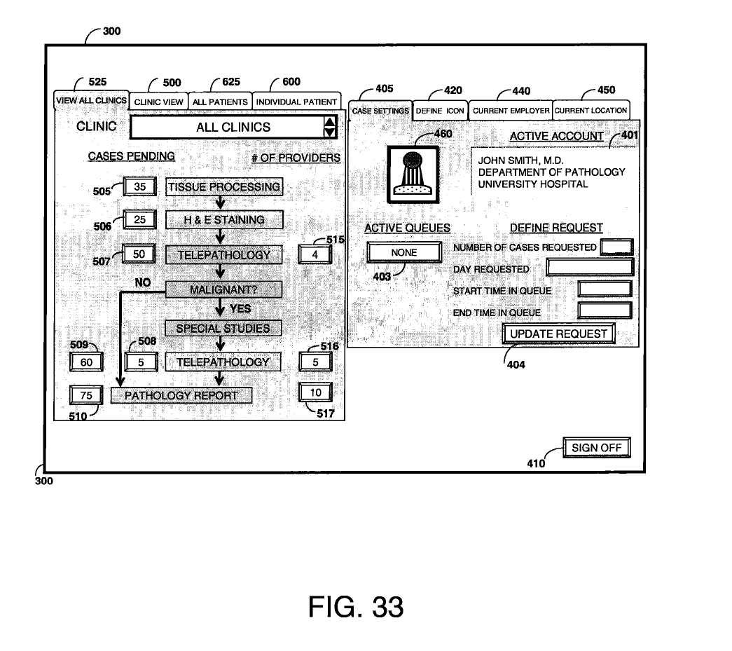

Referring to FIG. 33, an example opening screen for the provider, following successful login to command and control system, is shown. The panel on the right of the screen shows the account information for the person with the active account. For the depicted slides, the provider is medical professional Dr. Smith, Department of Pathology, University Hospital. From the depicted screen, the provider can elect to view the existing workload at all 525 or specific 526 clinics. Dr. Smith can also choose to update system settings and submit requests for cases 404. The next several slides show the process for viewing and managing workload. This workload can be viewed by the individual provider and managers, assuming appropriate security rights have been granted.

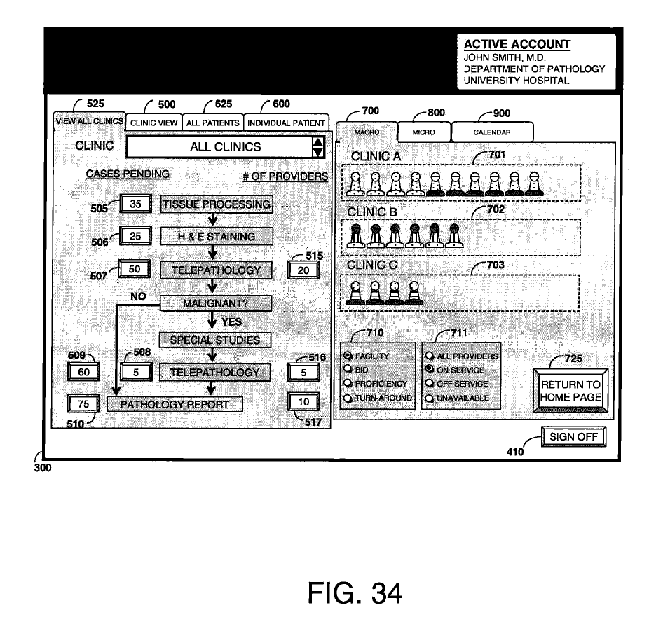

Referring to FIG. 34, the computer program presentation layer as seen in FIG. 32 shows how the provider or manager has opened their account on the command and control system. The provider or manager can open the screen shown in FIG. 34 by clicking the right button on the system mouse while the cursor is located over the telepathology block 527 on the left panel of the screen. The screen displays the icon view 701, 702 and 703 of all 20 providers registered 515 in the “Telepathology” queue. The icons can be sorted based on the buttons 710, 711 listed in the right panel. This view shows the four providers (i.e., represented by 20 icons) signed up for telepathology readings and is sorted by “Facility” 710 and “On Service” 703. The presentation layer shows “All Clinics” in the left field, corresponding to “Clinic A”, “Clinic B”, and “Clinic C” in the right field.

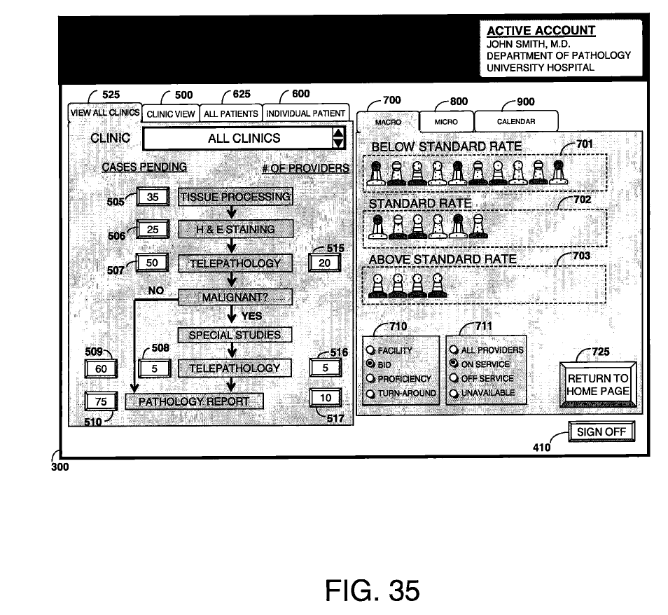

FIG. 35 shows the computer program presentation layer as in FIG. 34 and illustrates the same data sorted by “Bid” 710 and “On Service” 711. In the depicted example, the unique personal icons are broken into three categories based on the amount bid by the provider to perform the specific task. An individual provider may bid to do cases at different rates, as show in FIG. 35.

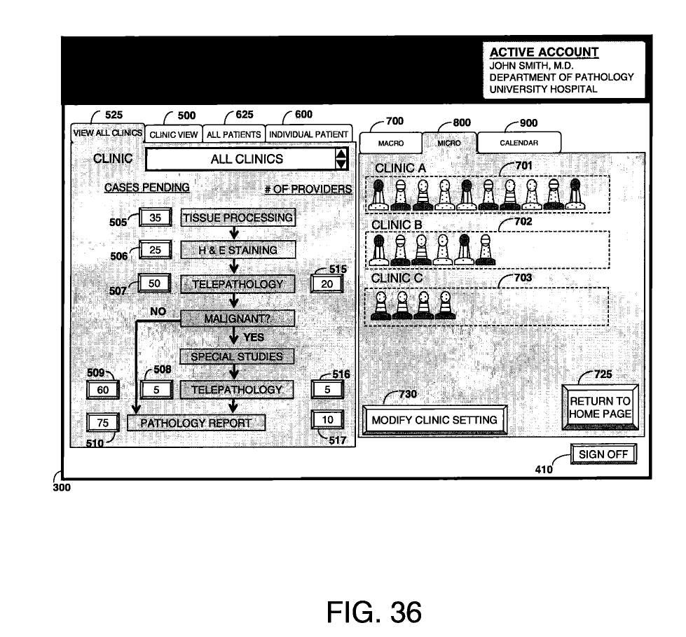

Referring to FIG. 36, the computer program presentation layer as seen in FIG. 35 is used to view and modify the distribution of service providers by clinic. FIG. 36 refers to specifically pathologists as the telepathology service providers. Similar menus would be used for other service providers such as radiologists providing teleradiology services for a clinical pathway. By selecting the “Micro” tab 800 on the right panel, the icons, each representing the availability of one service provider to provide a unit of service, such as reading out one telepathology slide or case, are shown in a box 701, 702, and 703, under their respective clinic. If an imbalance is noted by the manager, he or she can change the distribution by clicking on the “Modify Clinic Staffing” button 730 of the right panel.

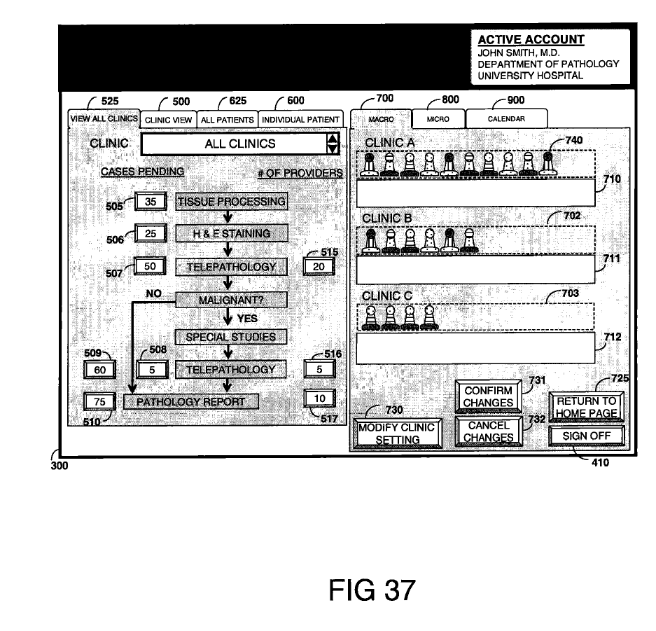

FIG. 37 shows the computer program presentation layer as in FIG. 36 and depicts the edit process for confirming 731 or canceling 732 screen changes. By selecting the “Macro” tab 700 on the right panel, edit boxes 710, 711, and 712 under the clinics appear and are used for the rearranging, by click and drag, of icons representing pathologists signed up to provide a unit of diagnostic service at “Clinic A”, “Clinic B” or “Clinic C”.

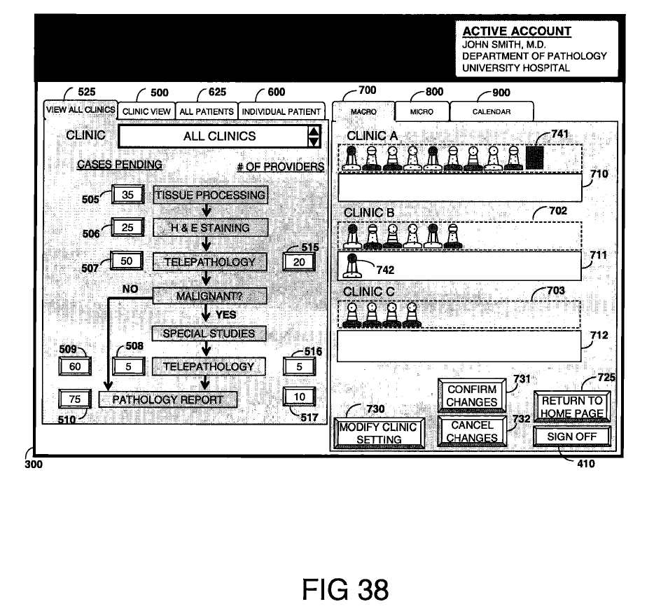

Referring to FIG. 38, the computer program presentation layer as seen in FIG. 37 shows how the workload can be balanced using the “Macro” tab 700. In the depicted example, the manager has clicked and dragged an icon 741 from “Clinic A” and placed it 742 in the edit box 711 of Clinic B. One unit of a service has been transferred from the queue for “Clinic A” to “Clinic B”. The manager can continue making changes in the same fashion or confirm/cancel the changes. For the depicted example, the manager will confirm changes by clicking on the “Confirm Changes” button 731.

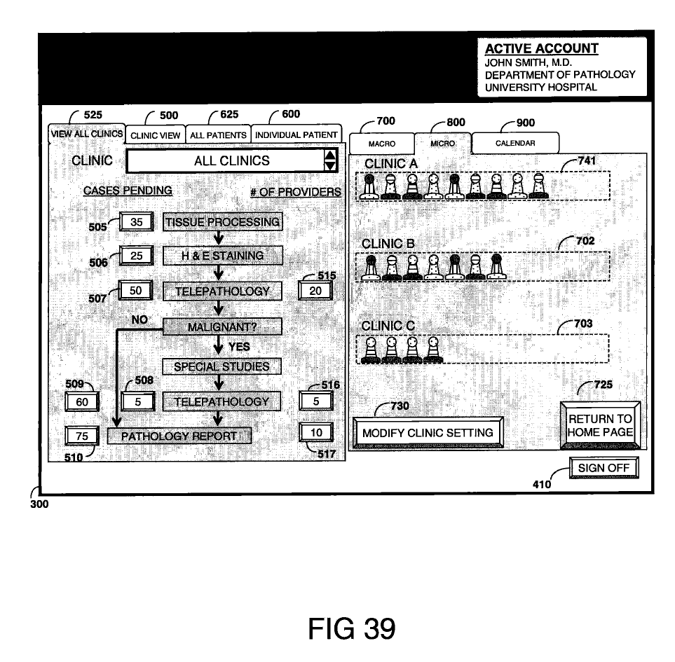

Referring to FIG. 39, the computer program presentation layer as seen in FIG. 38 shows the results of the previous action. The screen is refreshed showing the icon's new location in Clinic B's queue.

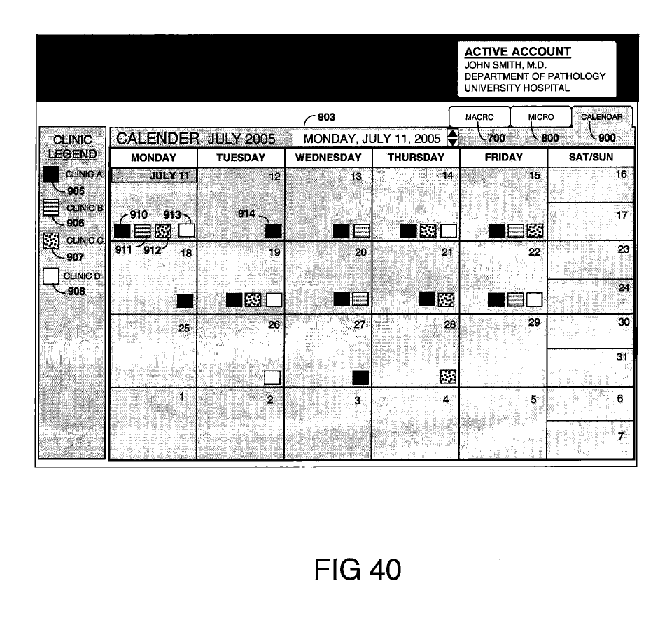

Referring to FIG. 40, the computer program presentation layer as seen in FIG. 39 shows the presentation layer screen once the “Calendar” tab 900 has been activated. The provider/manager can select the time period for viewing by using the time bar 903 in the center of the screen. Clinics to receive services are listed under “Clinic Legend”. The calendar shows the days with scheduled clinics and graphically represents the clinics 910, 911, 912, and 913.

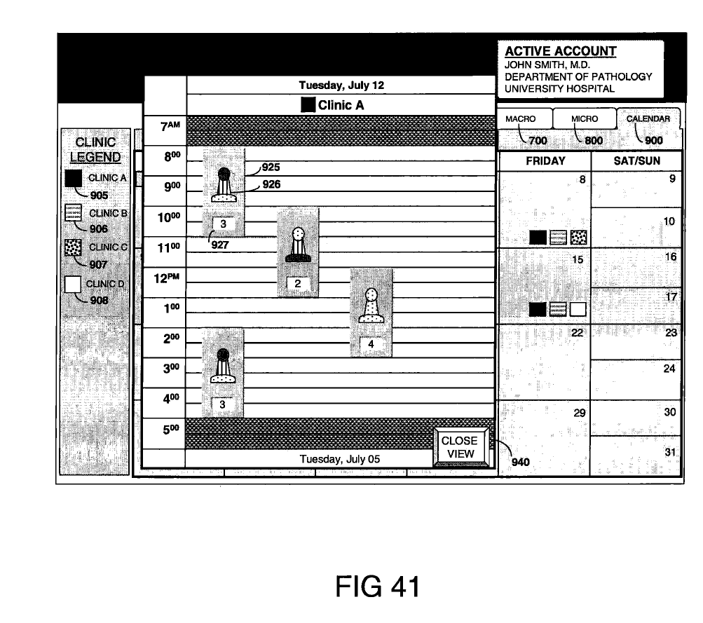

FIG. 41 shows the computer program presentation layer seen in FIG. 40, depicting the specific day selected by the manager/provider. Left clicking on a scheduled clinic 914 represented in FIG. 40 activates a screen which shows the time slots 925 for the clinic that day. Unique personal icons 926 are displayed by the times entered by the respective service provider. The register 927 beneath each 926 shows the number of units of service, such as case diagnoses, which the service provider represented by the icon is scheduled to supply.

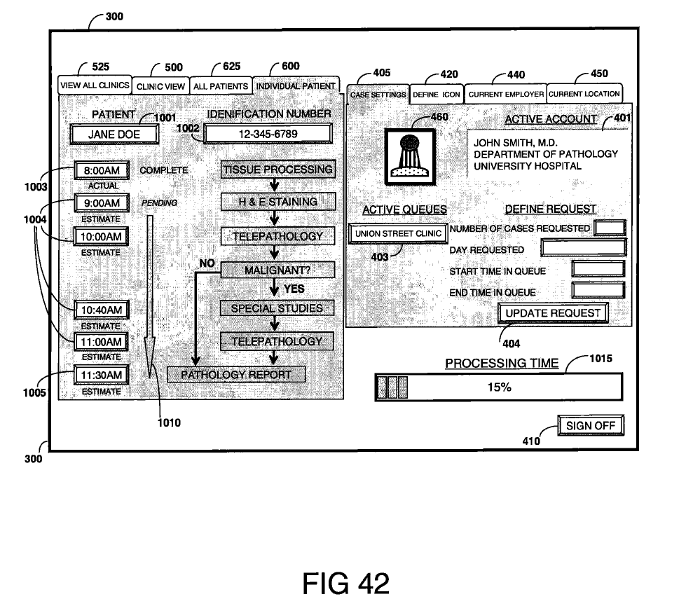

Referring to FIG. 42, the computer program presentation layer seen in FIG. 39 shows the provider and manager view of an individual patient identified by “Patient” name 1001 and “Identification Number” 1002. This view is refreshed when the user clicks on the “Individual Patient” tab 1002 of the left panel. The panel displays the various stages in processing the pathology test. Actual 1003 and estimated times 1004, 1005 are displayed on the left side of the panel inline with the stage of testing. On the lower right side of the screen is a process bar 1015 in which is reflected the percentage of completion of the process from “Tissue Processing” to “Pathology Report”. In this case, the tissue processing has been completed and the overall process is 15% completed 1015.

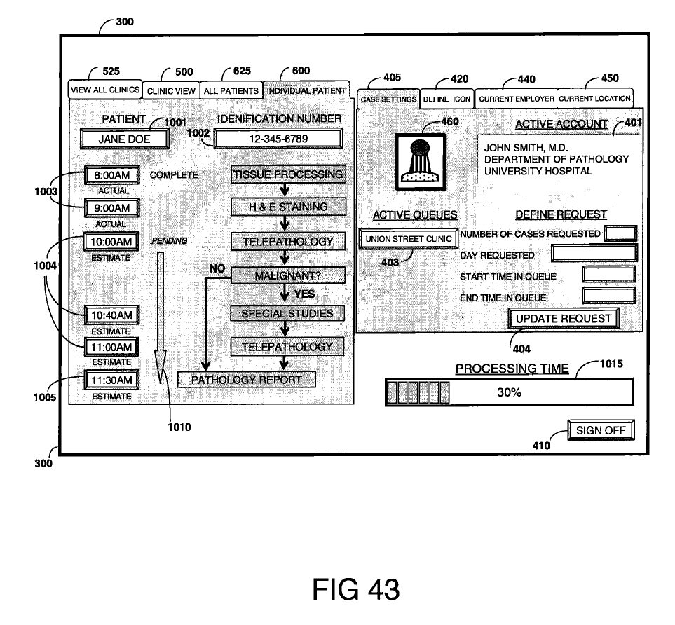

FIG. 43 shows the computer program presentation layer as seen in FIG. 42, depicting the same patient view selected by Dr. Smith, but also illustrating the update of the completed H and E staining. The progress bar 1015 reflects the change by increasing the percentage to 30%.

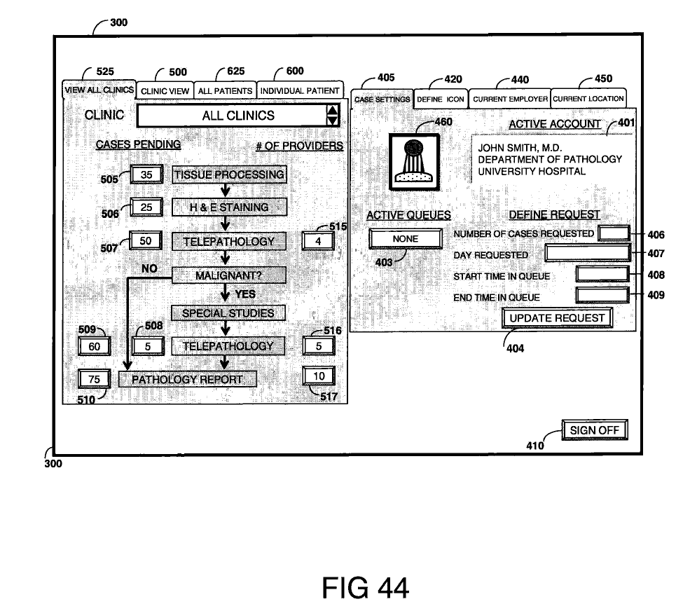

Referring to FIG. 44, the computer program presentation layer seen in FIG. 43 depicts the opening screen for the provider, following successful login to the command and control system. The panel on the right of the screen shows the account information for the person with the active account. For the depicted slides, the provider is Dr. Smith, Department of Pathology, University Hospital 401 who is not currently enrolled as a service provider in an “Active Queue” 403. From this screen, the provider can elect to view the existing workload at all clinics 525 or at a specific clinic 500. The provider can also choose to update system settings and submit requests for cases 406, 407, 408, 409. The next several slides show the process for viewing and managing workload. This workload can be viewed by the individual provider and managers, assuming appropriate security rights have been granted.

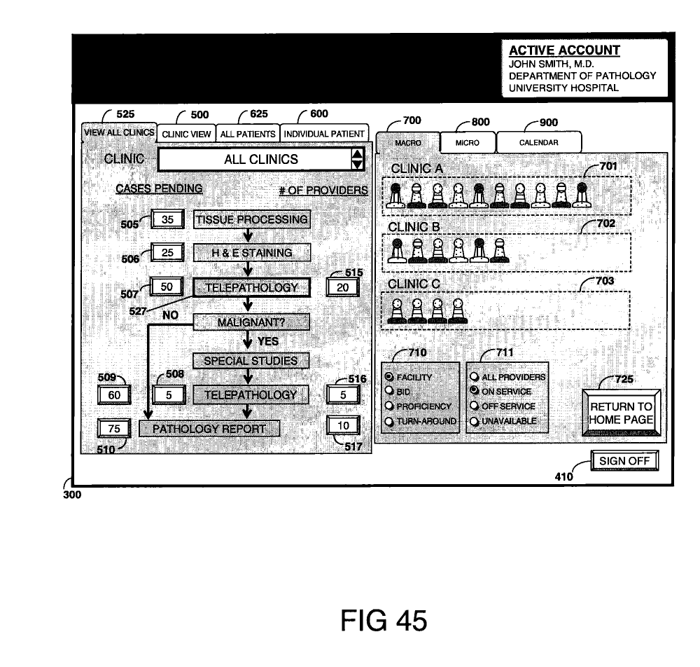

Referring to FIG. 45, the computer program presentation layer as seen in FIG. 44 is again seen, showing the opening screen for the manager who has opened his account on the command and control system. Managers can open this screen by clicking the right button on the system mouse while the cursor is located over the “Telepathology” 527 block on the left panel of the screen. On the right, this screen displays the icon view of all providers 701, 702, 703 registered in a “Telepathology” queue 527. The icons can be sorted based on the buttons listed in the right panel. This view shows the 20 providers signed up for telepathology readings and is sorted by “Facility” 710 and “On Service” 711.

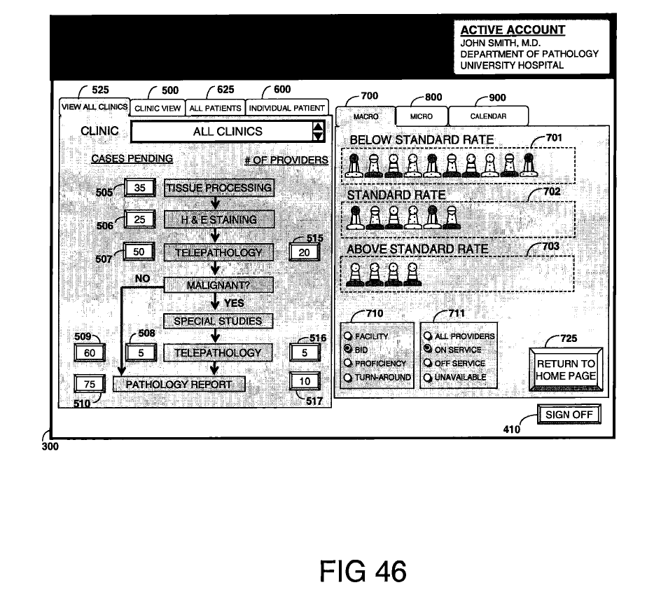

FIG. 46 shows the computer program presentation layer as seen in FIG. 45, depicting the same data sorted by “Bid” 710 and “On Service” 711. In this depiction, the icons are broken into three categories based on the amount bid by the provider to perform the specific task 701, 702, 703.

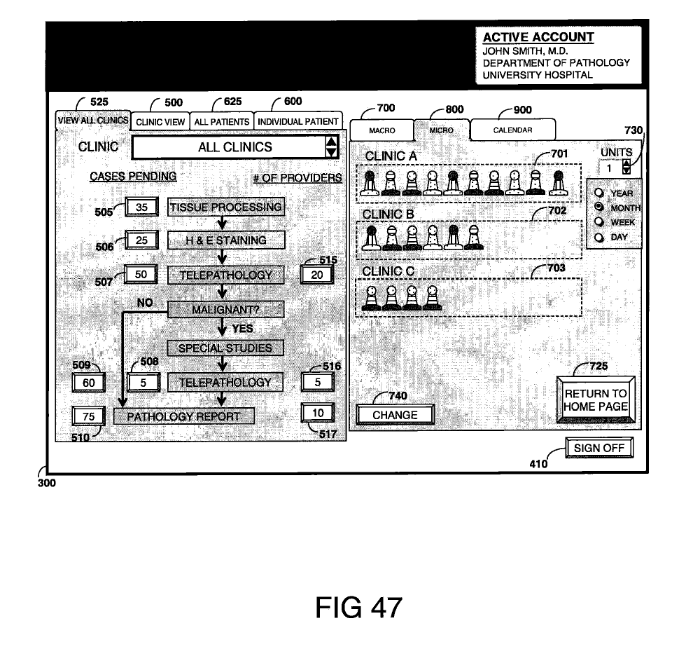

FIG. 47 shows the computer program presentation layer as in FIG. 46, further including the distribution of assigned providers by clinic 701, 702, 703. A provider can initiate adding or deleting entries on this screen by clicking the “Change” button 740 is used to change the number of cases or slides. Number of service units, such as number of cases or number of slides, are selected with the “Units” register 730. A plurality of identical icons in a row, called “icon clusters”, indicates that a single service provider will diagnose sequential cases.

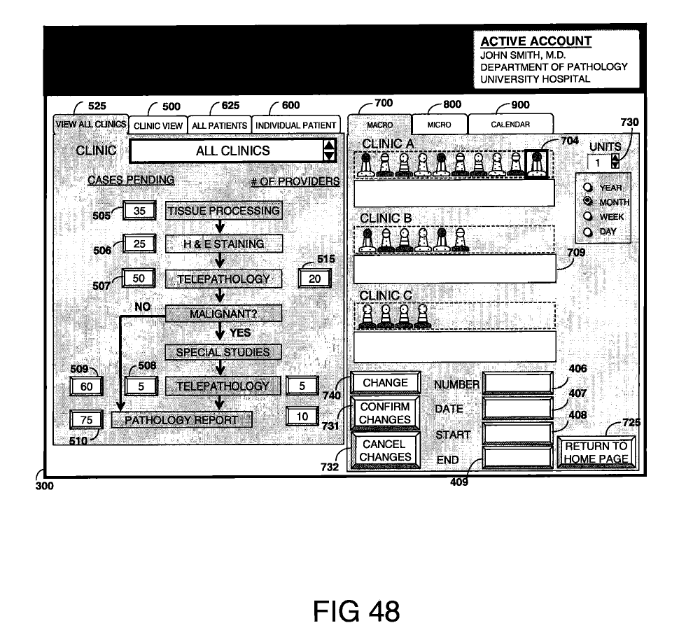

FIG. 48 shows the computer program presentation layer as in FIG. 47 and further depicts the activation of the “Change” button 740. Edit boxes appear below each clinic and two new buttons are added to the screen. One button is to confirm changes 731 and the other is to cancel changes 732. If a provider wishes to add an entry, he fills in the number 406, date 407, start time 408, and end 409 fields in the lower center portion of the panel.

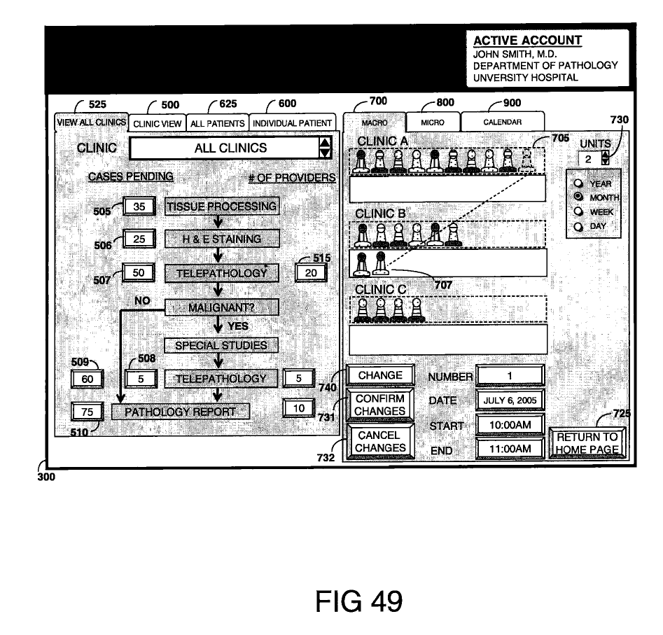

Referring to FIG. 49, the computer program presentation layer as seen in FIG. 48 further depicts how the service provider would add data by dropping a UPI 704 into the edit box of a clinic 709. The provider can continue making changes in the same fashion and confirm 731 or cancel 732 the changes. In this example, the “Unit” register 730 is set at “2”. The service provider clinics on an UPI 705 drags it to the edit box for “Clinic B”. Upon release of the mouse button, 2 copies 707 of the UPI from “Clinic A” 705 appear in the edit box. The action is finalized by clicking on the “Confirm Changes” button 731.

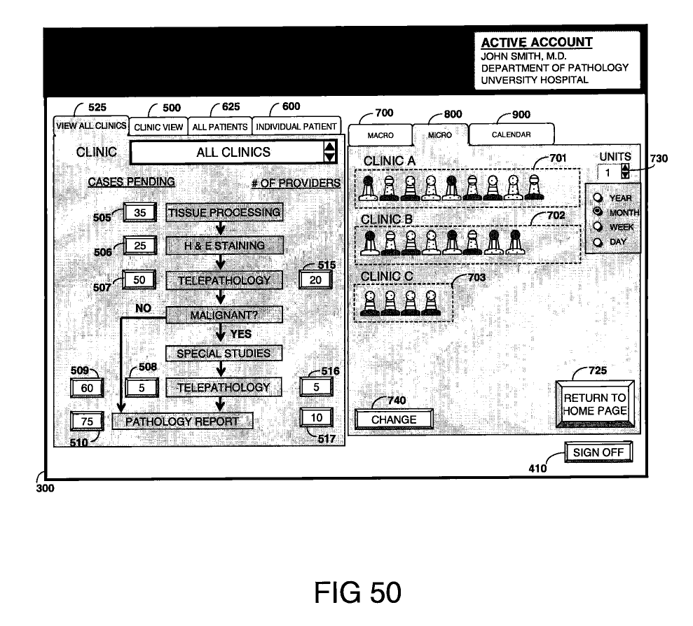

Referring to FIG. 50, the computer program presentation layer as seen in FIG. 49 further depicts the result of the previous action including the addition of two UPIs to the “Clinic B” data box 702. The screen is refreshed showing the two UPIs new location in Clinic B's queue.

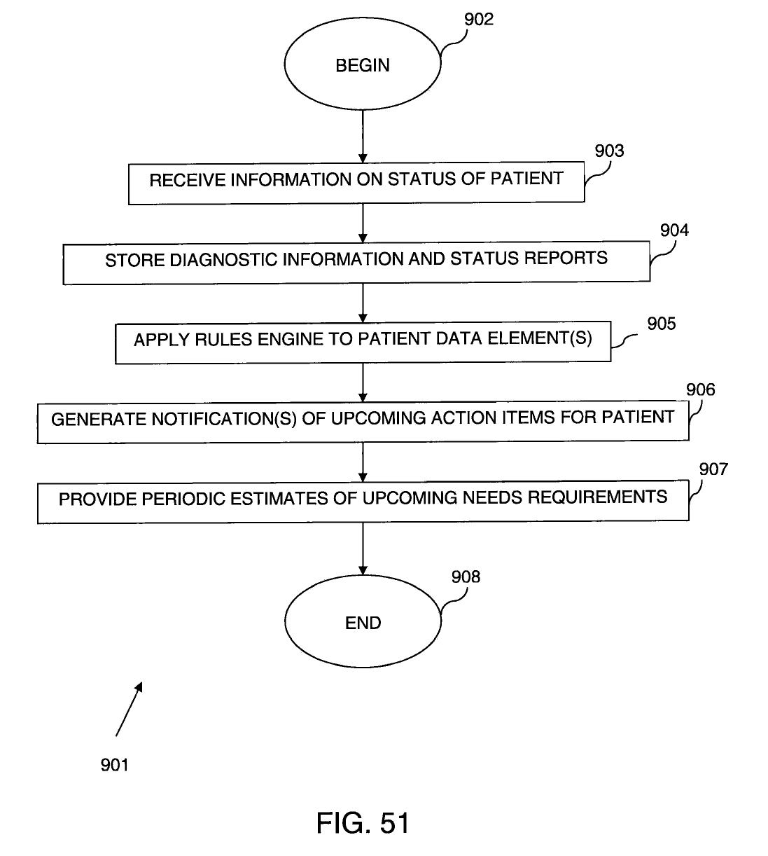

FIG. 51 illustrates an example method 901 of operation of a computerized patient care management system, according to the present invention. Method 901 begins (step 902) with the system receiving information on the status of a patient (step 903). The information received can relate to aspects of the clinical pathway of the patient. Once the status information is received, the system stores diagnostic information and status reports (step 904). The diagnostic information and status reports relate to how a respective patient is progressing through a respective clinical pathway.

As a next step, the system applies a rules engine to data element(s) of the respective patient (step 905). The rules engine can operate to organize the data elements by certain factors previously described, such as the stage of treatment, type of treatment, or qualitative factors such as urgency. Once the rules engine is applied to the data element(s), the system generates notification(s) of upcoming action items for the patient (step 906). The notification again can relate to certain aspects of the patient's respective clinical pathway. In one embodiment, the notification function is implemented through the use of the notification module 77K (see FIG. 4C) previously described.

The patient care management system can then provide periodic estimates of upcoming needs requirements of the healthcare system for professional services (step 907). In this way, the system manages resource allocation in an efficient manner. Finally, the method 901 ends (step 908).

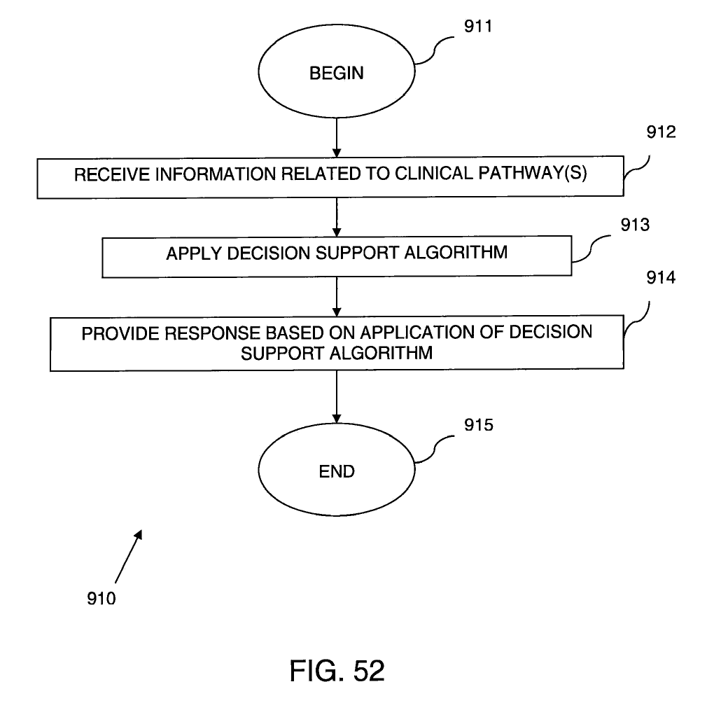

Turning to FIG. 52, a second example method 910 of operation of a patient care management system according to the present invention is depicted. Method 910 begins (step 911) with the system again receiving certain information related in some way to a respective clinical pathway. As a next step, the system applies a decision support algorithm (step 913). The decision support algorithm allows for the system to interpret information, organize, or disseminate the information in some way, again providing for greater resource allocation in the system. In one embodiment, the decision support algorithm includes a guideline of the practice relating to: Adrenal Disease, Bone Disease, Bone Marrow Disease, Brain Disease, Breast Disease, Cervix Disease, Connective Tissue Disease, Environmental Disease, Eye Disease, Gall Bladder Disease, Gastrointestinal Disease, Genetic Disease, Genitourinary Disease, Heart Disease Hereditary Disease, Infectious Disease, Kidney Disease, Liver Disease, Lung Disease, Lymph Node Disease, Metabolic Disease, Muscle Disease, Nervous System Disease, Oral Disease, Ovary Disease, Pancreas Disease, Penis Disease, Pineal Disease, Pituitary Disease, Prostate Disease, Skin Disease, Spleen Disease, Thymus Disease, Thyroid Disease, Urinary Track Disease, Uterus Disease, Vascular Disease, and Women's Health Disease.

Associated with implementation of the algorithm is the following step, where the system provides a response to the information (step 914). The response can include a notification, a task related to workflow control or scheduling, or some kind of database activity. Method 910 then ends (step 915).

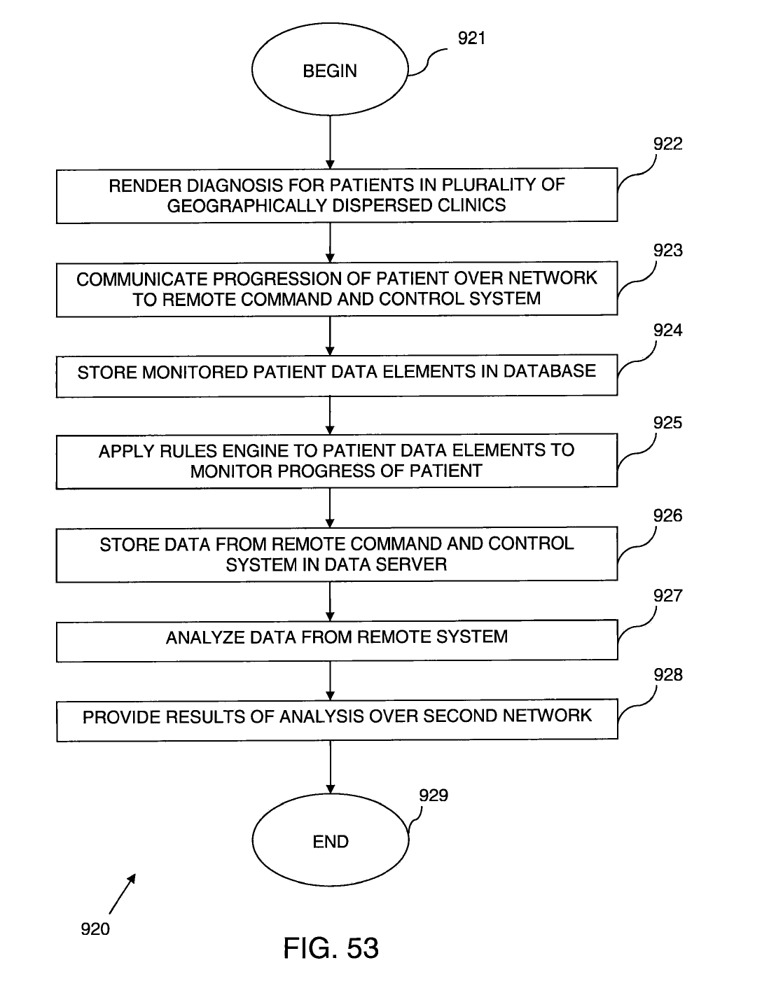

Turning to FIG. 53, an example method 920 of implementing various aspects of the present invention is depicted. Method 920 can be implemented by the execution of computer readable program code which operates on the overall command and control system 77 (see FIG. 4). Method 920 begins (step 921), with the task of a diagnosis rendered for a patient(s) in a plurality of geographically dispersed clinics (step 922). As a next step, the method 920 communicates over a network the progression of patients to a remote command and control center (step 923). The remote command and control center can include a database and related components previously described.

Monitored patient data can then be stored in the database (step 924). The database can include stored patient data elements in various forms. A rules engine can be applied to the patient data element(s) stored in the database (step 925). The application of the rules engine can serve to monitor the progress of a respective patient through a respective clinical pathway.

Data from the remote command and control system can be stored in a data server (926) in a variation of the embodiments depicted in FIG. 4B, the data server having similar subcomponentry. The data from the remote server can then be analyzed (step 927). The results from the analysis can be provided over a second network to the remote command and control system, or an additional remote command and control system in another location (step 928). Method 920 then ends (step 929).

A system and method of using decentralized medical specialists by telemedicine to provide a plurality of services to a patient in a single location has been shown. It will be apparent to those skilled in the art that other variations of the present invention are possible without departing from the scope of the invention described. For example, the approach can be used for patients with other kinds of cancers, such as prostate and certain, each of which may be detected by screening, setting in motion the events described in a clinical pathway. In such cases a system such as that described can be employed to expedite care and provide expertise using standardized clinical pathways across a number of geographically dispersed healthcare facilities.

The present invention implements a system and method for expediting the progress of a patient through a clinical pathway. By using telemedicine for off-site specialty services, and command and control system for managing the work-flow between a plurality of decentralized clinics, and an icon-based service provider tracking system, the efficiency of healthcare delivery is significantly increased. The presence of such a system dramatically decreases the current delays in providing patient access to important medical services.

What is claimed is:

1. A medical information management system, comprising:
a network;
means for connecting a plurality of geographically dispersed medical professionals over the network;
means for transmitting patient data to the plurality of medical professionals over the network;
a remote command and control system connected to the network, wherein the remote command and control system further includes:
a database having stored data on a first status of the plurality of medical professionals and a stored data element relating to a patient;
means for enrolling the plurality of geographically dispersed medical professionals in the medical information management system;
means for distributing a workload among the plurality of medical professionals;
a patient care management system adapted for:
receiving first information on a second status of a patient relating to a clinical pathway of the patient;
storing diagnostic information of the patient;
applying a rules engine to a data element stored in the database;
generating a notification of upcoming action items for the patient; and
providing periodic estimates of upcoming needs requirements of the medical information management system.

2. The medical information management system of claim 1, wherein the patient data element further includes a status of the patient in the clinical pathway or an updated assessment of the patient.

3. The medical information management system of claim 1, wherein the patient data element further includes a status of the patient in a schedule of actions or interventions represented by the clinical pathway.

4. The medical information management system of claim 1, wherein the geographically dispersed medical professionals individually serve as teleconsultants.

5. The medical information management system of claim 1, wherein the patient care management system further includes a data center having a plurality of data servers for storing and analyzing data from the remote command and control center.

6. The medical information management system of claim 1, wherein the patient care management system is further adapted to:
receive second information relating to clinical pathways,
apply a decision support algorithm, and
provide a response based upon the application of the decision support algorithm to the information.

7. The medical information management system of claim 6, wherein the decision support algorithm further includes a guideline of the practice relating to: Adrenal Disease, Bone Disease, Bone Marrow Disease, Brain Disease, Breast Disease, Cervix Disease, Connective Tissue Disease, Environmental Disease, Eye Disease, Gall Bladder Disease, Gastrointestinal Disease, Genetic Disease, Genitourinary Disease, Heart Disease Hereditary Disease, Infectious Disease, Kidney Disease, Liver Disease, Lung Disease, Lymph Node Disease, Metabolic Disease, Muscle Disease, Nervous System Disease, Oral Disease, Ovary Disease, Pancreas Disease, Penis Disease, Pineal Disease, Pituitary Disease, Prostate Disease, Skin Disease, Spleen Disease, Thymus Disease, Thyroid Disease, Urinary Track Disease, Uterus Disease, Vascular Disease, and Women's Health Disease.

8. A computer-implemented method of providing multiple diagnoses simultaneously to a plurality of geographically dispersed multi-specialty clinics from a remote location, comprising:
recording the diagnoses for patients obtained from the plurality of geographically dispersed multi-specialty clinics;
communicating a progression of a patient through a clinical pathway to a command and control system at a remote location via a first network;
storing a monitored patient data element in a database coupled through the command and control system; and
applying a rules engine to a patient data element stored in the database to monitor the progress of the patient through the clinical pathway.

9. The method of claim 8, further including:
storing data from the command and control system in a data center having a plurality of data servers,
analyzing the data from the command and control system, and
providing results of the analysis over a second network to the command and control system.

10. The method claim 8, further including transmitting audio from the plurality of geographically dispersed multi-specialty clinics via the network to the command and control system.

11. The method of claim 8, further including providing an on-call medical professional for a consultation simultaneously to the plurality of geographically dispersed multi-specialty clinics via the first network.

12. The method of claim 11, wherein the consultation further includes telepathology or teleradiology consultations.

13. A computer-implemented system for monitoring, distributing, and documenting healthcare resources to geographically dispersed patients and providers, comprising:
a workflow control module for controlling a patient flow, diagnostic images, and consultations documentation, the workflow control module including a database, wherein the workflow control module applies a rules engine to a patient data element stored in the database to monitor the progress of the patient through a clinical pathway;
a business activity monitoring module, connected to the workflow control module, for providing management information on productivity and distribution of workload;
a notification module, connected to the business activity monitoring module, for providing alerts to requesters, providers, and clinic management;
a workload queuing module, operational in conjunction with the workflow control module, for controlling incoming requests and to insure the incoming requests are received and processed in a defined order; and
a scheduling module, operational in conjunction with the workflow control module, for scheduling available resources.

14. The system of claim 13, wherein the workflow control module further includes a component for distributing a clinic resource.

15. The system of claim 13, wherein the workflow control module implements a method for controlling the flow of patients, diagnostic images, and consultations documentation.

16. The system of claim 13, wherein the workflow control module implements a method for a medical professional to electronically bid on available clinical consults.

17. The system of claim 13, wherein the workflow control module further includes an icon-based presentation layer allowing a credentialed provider to define a unique demographic and clinical role.

18. The system of claim 13, wherein the workflow control module further includes multiple data elements which comprise a super-rapid clinic network encounter record or workflow database.

19. The system of claim 13, wherein the workflow control module contains an electronic communications infrastructure that provides electronic connectivity of provider workstations and mobile computing devices and a super-rapid clinic network workflow database.

20. The system of claim 13, wherein the business activity monitoring module incorporates a component for monitoring the clinic's resources, both equipment and personnel.

21. The system of claim 13, wherein the business activity monitoring module includes a method for monitoring and documenting the availability of service providers.

22. The system of claim 13, wherein the notification module further includes a subsystem for electronically alerting clinical and administrative personnel.

23. The system of claim 13, wherein the notification module further includes a method for electronically notifying super-rapid clinic network personnel regarding the status of clinical consultations.

24. The system of claim 13, wherein the notification module implements a rules engine for determining a method and frequency for personnel notification.

25. The system of claim 13, wherein the notification module implements a method for electronically notifying super-rapid clinical network personnel when pre-established queuing thresholds have been reached or exceeded.

26. The system of claim 13, wherein the workload queuing module further includes a subsystem for electronically receiving incoming requests for services and distributing the requests in the appropriate electronic queue.

27. The system of claim 13, wherein the workload queuing module implements a method for electronically distributing clinical consultations.

28. The system of claim 13, wherein the scheduling module further includes a system for electronically scheduling the rapid clinical network personnel and equipment resources.

29. The system of claim 13, wherein the scheduling module further includes a subsystem for electronically maintaining the schedules for clinicians and diagnostic equipment.

30. A computer-implemented information management system for an individual healthcare service provider or pool of providers, comprising:
an enrollment module for electronically enrolling the healthcare service provider, or pool of providers, in a provider pool, wherein the enrollment module allows the individual healthcare service provider to generate a computer graphic element including a unique personal icon (UPI) to be used to represent the individual healthcare service provider in presentation layers of the information management system;
an eligibility module for establishing the eligibility for the healthcare service provider, or pool of providers, in the provider pool;
a tracking module for tracking the level of activity of the individual healthcare service providers, or pool of providers, and tracking the proficiency of the individual healthcare service provider, or pool of providers; and
a recording module for recording the billing and reimbursement activities of the individual healthcare service provider, or pool of providers.

31. The system of claim 30, wherein the enrollment module enables the individual healthcare provider to generate UPIs based on a standardized format.

32. The system of claim 30, wherein the enrollment module enables the individual healthcare provider to assemble UPIs that fuse multiple graphically coded identifier features.

33. The system of claim 30, wherein the enrollment module enables the individual healthcare provider to mask a personal identity of the individual healthcare provider.

34. The system of claim 30, wherein the enrollment module links the UPI to service provider identification information that is security protected.

35. The system of claim 30, wherein the enrollment module allows the healthcare service provider to electronically transport a version of the UPI belonging to the healthcare service provider.

36. The system of claim 30, wherein the enrollment module allows the healthcare service provider to electronically transport a copy of the UPI belonging to the healthcare service provider into a presentation layer work flow control screen representing an individual patients clinical pathway.

37. The system of claim 30, wherein the eligibility module allows the healthcare service provider to electronically position the UPI into a specific step in a clinical pathway to establish eligibility and availability to perform a specific function in the clinical pathway.

39. The system of claim 30, wherein the enrollment module allows the healthcare service provider to electronically clone the healthcare service provider.

40. The system of claim 30, wherein the tracking module monitors self-generated screen-based appointments of the individual healthcare service provider to ensure non-overlap of time commitments and time availability.

41. The system of claim 30, wherein the UPI is archived in a UPI library.

42. The system of claim 30, wherein a first UPI is compared against a master collection of UPIs to ensure that the first UPI is visually unique, whereupon if the first UPI is not visually unique, a selection of the first UPI is blocked and a visually unique substitute is generated for use as a substitute first UPI.
